(19) United States
(12) Patent Application Publication
(10) Pub. No.: US 2025/0175932 A1
(43) Pub. Date: May 29, 2025

(54) SIDELINK POSITIONING MEASUREMENT PROCEDURES

(71) Applicant: Lenovo (Singapore) Pte. Limited, Singapore (SG)

(72) Inventors: Robin Rajan Thomas, Frankfurt (DE); Karthikeyan Ganesan, Kronberg Im Taunus (DE); Abir Ben Hadj Fredj, Wiesbaden (DE); Colin Frank, Park Ridge, IL (US); Ankit Bhamri, Rödermark (DE); Ali Ramadan Ali, Kraiburg (DE)

(73) Assignee: Lenovo (Singapore) Pte. Limited, Singapore (SG)

(21) Appl. No.: 18/836,661

(22) PCT Filed: Feb. 1, 2023
(86) PCT No.: PCT/IB2023/050893

§ 371 Date: Aug. 7, 2024

Related U.S. Application Data
(60) Provisional application No. 63/307,453, filed on Feb. 7, 2022.

(51) Int. Cl. H04W 64/00; H04W 24/10; H04W 92/18

(52) U.S. Cl. CPC H04W 64/00; H04W 24/10; H04W 92/18

(57) ABSTRACT

Various aspects of the present disclosure relate to sidelink positioning measurement procedures. A configuring device can transmit a sidelink measurement window configuration to a responding device that performs sidelink positioning measurements based on the sidelink measurement window configuration. The configuring device can then receive the sidelink positioning measurements from the responding device. The responding device can receive the sidelink measurement window configuration from the configuring device, and perform the sidelink positioning measurements based on the sidelink measurement window configuration. The responding device can then transmit the sidelink positioning measurements for the responding device to the configuring device.

### RELATED APPLICATION

This application claims priority to U.S. Patent Application Ser. No. 63/307,453 filed Feb. 7, 2022 entitled “Sidelink Positioning Measurement Procedures,” the disclosure of which is incorporated by reference herein in its entirety.

### TECHNICAL FIELD

The present disclosure relates to wireless communications, and more specifically to sidelink positioning measurement procedures.

### BACKGROUND

A wireless communications system may include one or multiple network communication devices, such as base stations, which may be otherwise known as an eNodeB (eNB), a next-generation NodeB (gNB), or other suitable terminology. Each network communication device, such as a base station, may support wireless communications for one or multiple user communication devices, which may be otherwise known as user equipment (UE), or other suitable terminology. The wireless communications system may support wireless communications with one or multiple user communication devices by utilizing resources of the wireless communication system, such as time resources (e.g., symbols, slots, subslots, mini-slots, aggregated slots, subframes, frames, or the like) or frequency resources (e.g., subcarriers, carriers). Additionally, the wireless communications system may support wireless communications across various radio access technologies (RATs) including third generation (3G) RAT, fourth generation (4G) RAT, fifth generation (5G) RAT, and other suitable RATs beyond 5G. In some cases, a wireless communications system may be a non-terrestrial network (NTN), which may support various communication devices for wireless communications in the NTN. For example, an NTN may include network entities onboard non-terrestrial vehicles such as satellites, unmanned aerial vehicles (UAV), and high-altitude platforms systems (HAPS), as well as network entities on the ground, such as gateway entities capable of transmitting and receiving over long distances.

The wireless communications system enables UE-assisted and UE-based positioning methods in the third generation partnership project (3GPP) positioning framework. Typically, a UE can perform measurement and processing of the Uu interface positioning reference signals prior to reporting the measurements to a location server in the wireless communications system. However, UE-to-UE range and orientation determinations are not supported, which would facilitate relative positioning applications across other services, such as for vehicle-to-everything (V2X), public safety, industrial Internet of things (IIoT), commercial, and other applications.

### SUMMARY

The present disclosure relates to methods, apparatuses, and systems that support sidelink positioning measurement procedures. By utilizing the described techniques, a network entity (e.g., a UE or other sidelink enabled device) and a sidelink device are operable to implement various aspects of the sidelink positioning measurement procedures. Either of the network entity (e.g., a UE or other device) and/or the sidelink device may be implemented in the wireless communications system as a UE, a base station, a roadside unit, an anchor UE, a target UE, a reference UE, a location server, an unmanned or uncrewed ariel vehicle (UAV) (e.g., a drone), and/or as any other type of network devices or entities performing procedures for sidelink positioning measurement. For instance, the network device can transmit a measurement window configuration to the sidelink device via a sidelink communication link. In various implementations, the measurement window configuration may be a sidelink measurement window configuration, a joint Uu and sidelink measurement window configuration, a measurement window configuration as part of a response time, a common measurement window configuration, or a measurement window configuration set. The sidelink device receives the measurement window configuration from the network device and performs sidelink positioning measurements based on the received sidelink measurement window configuration. Accordingly, the sidelink device generates a response of the sidelink positioning measurements for the sidelink device, and the sidelink positioning measurements are transmitted back to the network device.

Some implementations of the method and apparatuses described herein may include wireless communication at a device (e.g., a UE, responding device as an apparatus), and the device receives a sidelink measurement window configuration from a configuring device. The responding device can perform sidelink positioning measurements based on the sidelink measurement window configuration, and transmit the sidelink positioning measurements for the apparatus to the configuring device.

In some implementations of the method and apparatuses described herein, the sidelink measurement window configuration includes multiple instances of sidelink positioning reference signals (PRS), and the sidelink positioning measurements are averaged over the multiple instances of the sidelink PRS. The responding device can also perform sidelink timing error mitigation based on one or more of the multiple instances of the sidelink PRS. The responding device can jointly perform the sidelink positioning measurements, as well as downlink positioning measurements or uplink positioning measurements. The sidelink measurement window configuration includes multiple pre-defined time instances of sidelink PRS, and the responding device can compute absolute location information and/or relative location information for one or more of the multiple pre-defined time instances of the sidelink PRS. The responding device can also prioritize the sidelink positioning measurements performed within the configured sidelink measurement window.

In implementations, the sidelink measurement window configuration may be a common configuration applicable to multiple responding devices, and the device performs the sidelink positioning measurements based on instances of sidelink PRS corresponding to the responding device in the sidelink measurement window configuration. The responding device can receive a configuration of a sidelink expected reference signal time difference (RSTD) search window, and measure a sidelink RSTD within the sidelink expected RSTD search window. In implementations, the responding device may be a roadside unit, an anchor UE, or one or more UE configured for sidelink positioning configuration and measurements.

Some implementations of the method and apparatuses described herein may include wireless communication at a device (e.g., a network entity, configuring device as an apparatus), and the device transmits a sidelink measurement window configuration to a responding device that performs sidelink positioning measurements based on the sidelink measurement window configuration. The configuring device receives the sidelink positioning measurements from the responding device.

In some implementations of the method and apparatuses described herein, the sidelink measurement window configuration is configured to a group of responding devices for groupcast sidelink positioning. The configuring device can transmit the sidelink measurement window configuration to the group of responding devices that perform respective sidelink positioning measurements, and receive the respective sidelink positioning measurements from one or more of the responding devices. The sidelink measurement window configuration can be configured as a common measurement window configuration to the group of responding devices for the groupcast sidelink positioning. Alternatively, the sidelink measurement window configuration can be configured as separate measurement window configurations to a subset of the responding devices for the groupcast sidelink positioning.

In implementations, the configuring device is a base station, a roadside unit, a location server, an anchor UE, or a target UE. The configuring device can transmit the sidelink measurement window configuration utilizing broadcast signaling or dedicated signaling. The broadcast signaling includes groupcast messages, positioning information blocks, and/or vehicle to everything (V2X) system information blocks, and the dedicated signaling includes PC5 radio resource control (RRC), RRC, medium access control element (MAC CE), or LTE positioning protocol (LPP). The configuring device can transmit a sidelink expected RSTD search window configuration, where a sidelink RSTD search window is configured to one or more responding devices to accurately measure the actual RSTD from a pair of anchor devices. The configuring device can configure a sidelink RSTD search window for a same sidelink positioning frequency layer or for different sidelink positioning frequency layers. The sidelink RSTD search window configuration information includes an expected sidelink RSTD duration as a function of a time instance interval, and includes sidelink RSTD uncertainty indicating error margins of the sidelink expected RSTD window.

### BRIEF DESCRIPTION OF THE DRAWINGS

Various aspects of the present disclosure for sidelink positioning measurement procedures are described with reference to the following Figures. The same numbers may be used throughout to reference like features and components shown in the Figures.

FIG. 1 illustrates an example of a wireless communications system that supports sidelink positioning measurement procedures in accordance with aspects of the present disclosure.

FIG. 2 illustrates an example of absolute and relative positioning scenarios as related to sidelink positioning measurement procedures in accordance with aspects of the present disclosure.

FIG. 3 illustrates an example of a multi-cell RTT procedure as related to sidelink positioning measurement procedures in accordance with aspects of the present disclosure.

FIG. 4 illustrates an example of a system for existing relative range estimation as related to sidelink positioning measurement procedures in accordance with aspects of the present disclosure.

FIG. 5 illustrates an example of a system for NR beam-based positioning as related to sidelink positioning measurement procedures in accordance with aspects of the present disclosure.

FIG. 6 illustrates an example of an LTE positioning protocol (LPP) request location information message as related to sidelink positioning measurement procedures in accordance with aspects of the present disclosure.

FIG. 7 illustrates an example of a LPP provide location information message as related to sidelink positioning measurement procedures in accordance with aspects of the present disclosure.

FIG. 8 illustrates an example of sidelink measurement window configuration that supports sidelink positioning measurement procedures in accordance with aspects of the present disclosure.

FIG. 9 illustrates an example of joint Uu and sidelink positioning measurement window configuration that supports sidelink positioning measurement procedures in accordance with aspects of the present disclosure.

FIG. 10 illustrates an example of a measurement window configuration as part of response time signaling that supports sidelink positioning measurement procedures in accordance with aspects of the present disclosure.

FIG. 11 illustrates an example of a common measurement window configuration for groupcast positioning that supports sidelink positioning measurement procedures in accordance with aspects of the present disclosure.

FIG. 12 illustrates an example of a separate measurement window configuration for groupcast positioning that supports sidelink positioning measurement procedures in accordance with aspects of the present disclosure.

FIG. 13 illustrates an example of a sidelink positioning configuration that supports sidelink positioning measurement procedures in accordance with aspects of the present disclosure.

FIG. 14 illustrates an example of an adapted RSTD search window for performing sidelink TDOA on a same sidelink positioning frequency layer, which supports sidelink positioning measurement procedures in accordance with aspects of the present disclosure.

FIG. 15 illustrates an example of an adapted RSTD search window for performing sidelink TDOA on different sidelink positioning frequency layers, which supports sidelink positioning measurement procedures in accordance with aspects of the present disclosure.

FIG. 16 illustrates an example block diagram of components of a device (e.g., a responding device, sidelink implemented UE) that supports sidelink positioning measurement procedures in accordance with aspects of the present disclosure.

FIG. 17 illustrates an example block diagram of components of a device (e.g., a configuring device, sidelink network entity) that supports sidelink positioning measurement procedures in accordance with aspects of the present disclosure.

FIGS. 18-21 illustrate flowcharts of methods that support sidelink positioning measurement procedures in accordance with aspects of the present disclosure.

### DETAILED DESCRIPTION

Implementations of sidelink positioning measurement procedures are described, such as related to aspects of the measurement functionality for sidelink (SL) reference signals to be configured and reported, supporting the accurate and timely measurement of different sidelink RAT-dependent positioning methods. This disclosure details several implementations supporting sidelink (PC5) positioning measurement and configurations related to a UE's sidelink positioning processing capabilities and uplink (UL) resource availability to support absolute and relative positioning in a variety of latency, accuracy, and coverage scenarios. Aspects of the disclosure include implementations to configure a sidelink measurement window for performing sidelink measurements, such as for positioning calculation, time drift correction, joint Uu and SL positioning measurements, deferred location measurement, and computation and groupcast sidelink positioning. Additionally, the disclosure provides for the measurement configuration in different coverage scenarios, including in-coverage, partial coverage, and out-of-coverage, and a method to configure the reporting of the sidelink positioning measurements based on the measurement window configuration is described. Further, the described aspects provide to configure an expected reference signal time difference (RSTD) window for SL-TDOA for the same and different sidelink positioning frequency layers.

Typically, a UE can perform measurement and processing of the Uu interface positioning reference signals prior to reporting the measurements to a location server in a wireless communications system. The conventional system supports UE-assisted and UE-based positioning methods in the 3GPP positioning framework. However, UE-to-UE range and orientation determinations are not supported, which would facilitate relative positioning applications across other services, such as for vehicle-to-everything (V2X), public safety, industrial Internet of things (IIoT), commercial, and other applications. For the described sidelink positioning measurement procedures, timely and accurate measurements are essential to obtain high absolute and relative positioning accuracy. Unlike the traditional positioning, the described sidelink positioning takes into account moving and distributed nodes, varying mobility, the availability of anchor and non-anchor entities, uncertainty about the measurement, and so on. At the same time, the sidelink positioning provides the advantages of range and orientation estimation which is essential for tracking and position estimation for UEs with respect to other UEs.

Aspects of the disclosure include performing measurement and processing of sidelink positioning reference signals, supporting different sidelink UEs that may have different processing capabilities ranging from basic to advanced devices. The described sidelink positioning measurement procedures include an implementation to configure a sidelink measurement window for performing sidelink measurements for positioning calculation, time drift correction, joint Uu and SL positioning measurements, deferred location measurement, and computation and groupcast sidelink positioning. The sidelink positioning measurement procedures also include an implementation to support the measurement configuration in different coverage scenarios, including in-coverage, partial coverage, and out-of-coverage. The sidelink positioning measurement procedures also include an implementation to configure the reporting of the sidelink positioning measurements based on the measurement window configuration. The sidelink positioning measurement procedures also include an implementation to configure an expected reference signal time difference (RSTD) window for SL-time difference of arrival (TDOA) for the same and different sidelink positioning frequency layers.

A sidelink measurement window configuration enables measurements of sidelink RAT-dependent and RAT-independent measurements, which can enable correction of timing drifts in sidelink positioning over different resource granularities. This also allows for performing joint Uu and SL RAT-dependent measurements, which can be combined at the positioning calculation entity. This also enables a pre-defined time in advance, during which the UE may trigger measurements in order to anticipate the response time. This also enables a common or dedicated time interval during which member UEs in a groupcast positioning session may perform the requested sidelink positioning measurements. The sidelink measurement window can be applicable to different in-coverage, partial coverage, and out-of-coverage scenarios. The positioning reporting framework for UEs configured with a sidelink measurement window are also described. Further, a new, adapted configuration for SL-TDOA with respect to the expected RSTD of a non-reference and reference sidelink anchor node is described herein for different positioning frequency layers.

In an implementation, the sidelink measurement window configuration is described based on different functionalities, including the correction of timing drifts, enabling timely measurement of both joint Uu and SL positioning measurements, supporting a deferred location computation based on the response time, and supporting groupcast positioning measurements by different member UEs. In another implementation, the sidelink measurement window configuration is described for different scenarios that facilitate in-coverage, partial coverage, and out-of-coverage scenarios. Further, an expected RSTD search window can be implemented to enable the sidelink measuring UE or network device to compute the actual RSTD between a reference anchor node and a secondary (i^{th}) anchor node in a predefined manner.

Aspects of the present disclosure are described in the context of a wireless communications system. Aspects of the present disclosure are further illustrated and described with reference to device diagrams and flowcharts that relate to sidelink positioning measurement procedures.

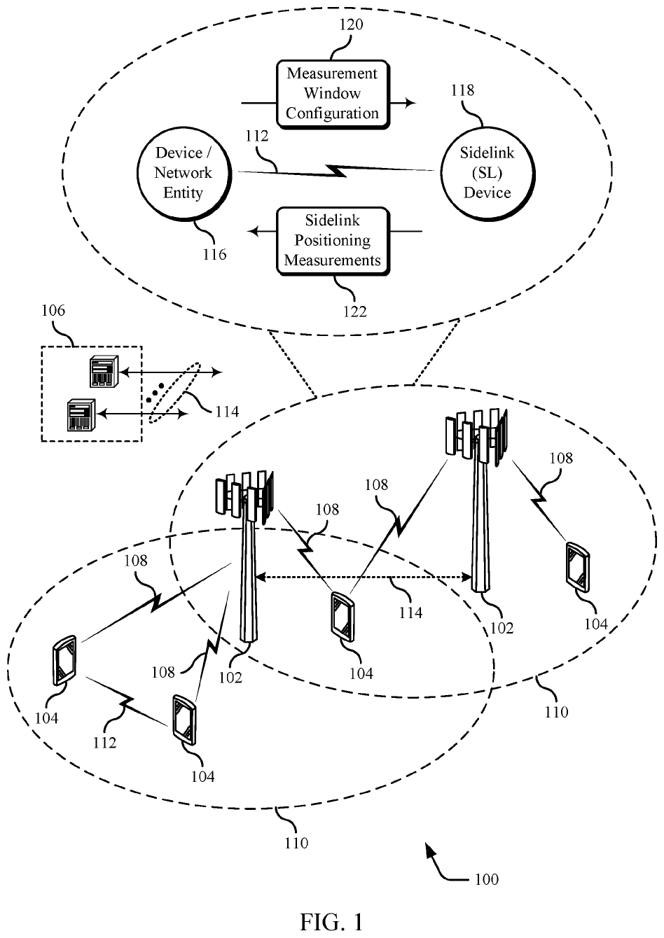

FIG. 1 illustrates an example of a wireless communications system 100 that supports sidelink positioning measurement procedures in accordance with aspects of the present disclosure. The wireless communications system 100 may include one or more base stations 102, one or more UEs 104, and a core network 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a 5G network, such as a NR network. In other implementations, the wireless communications system 100 may be a combination of a 4G network and a 5G network. The wireless communications system 100 may support radio access technologies beyond 5G. Additionally, the wireless communications system 100 may support technologies, such as time division multiple access (TDMA), frequency division multiple access (FDMA), or code division multiple access (CDMA), etc.

The one or more base stations 102 may be dispersed throughout a geographic region to form the wireless communications system 100. One or more of the base stations 102 described herein may be, or include, or may be referred to as a base transceiver station, an access point, a NodeB, an eNodeB (eNB), a next-generation NodeB (gNB), a Radio Head (RH), a relay node, an integrated access and backhaul (IAB) node, or other suitable terminology. A base station 102 and a UE 104 may communicate via a communication link 108, which may be a wireless or wired connection. For example, a base station 102 and a UE 104 may perform wireless communication over a NR-Uu interface.

A base station 102 may provide a geographic coverage area 110 for which the base station 102 may support services (e.g., voice, video, packet data, messaging, broadcast, etc.) for one or more UEs 104 within the geographic coverage area. For example, a base station 102 and a UE 104 may support wireless communication of signals related to services (e.g., voice, video, packet data, messaging, broadcast, etc.) according to one or multiple radio access technologies. In some implementations, a base station 102 may be moveable, such as when implemented as a gNB onboard a satellite or other non-terrestrial station (NTS) associated with a non-terrestrial network (NTN). In some implementations, different geographic coverage areas 110 associated with the same or different radio access technologies may overlap, and different geographic coverage areas 110 may be associated with different base stations 102. Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The one or more UEs 104 may be dispersed throughout a geographic region or coverage area 110 of the wireless communications system 100. A UE 104 may include or may be referred to as a mobile device, a wireless device, a remote device, a handheld device, a customer premise equipment (CPE), a subscriber device, or as some other suitable terminology. In some implementations, the UE 104 may be referred to as a unit, a station, a terminal, or a client, among other examples. Additionally, or alternatively, a UE 104 may be referred to as an Internet-of-Things (IoT) device, an Internet-of-Everything (IoE) device, or as a machine-type communication (MTC) device, among other examples. In some implementations, a UE 104 may be stationary in the wireless communications system 100. In other implementations, a UE 104 may be mobile in the wireless communications system 100, such as an earth station in motion (ESIM).

The one or more UEs 104 may be devices in different forms or having different capabilities. Some examples of UEs 104 are illustrated in FIG. 1. A UE 104 may be capable of communicating with various types of devices, such as the base stations 102, other UEs 104, or network equipment (e.g., the core network 106, a relay device, a gateway device, an integrated access and backhaul (IAB) node, a location server that implements the location management function (LMF), or other network equipment). Additionally, or alternatively, a UE 104 may support communication with other base stations 102 or UEs 104, which may act as relays in the wireless communications system 100.

A UE 104 may also support wireless communication directly with other UEs 104 over a communication link 112. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link 112 may be referred to as a sidelink. For example, a UE 104 may support wireless communication directly with another UE 104 over a PC5 interface.

A base station 102 may support communications with the core network 106, or with another base station 102, or both. For example, a base station 102 may interface with the core network 106 through one or more backhaul links 114 (e.g., via an S1, N2, or other network interface). The base stations 102 may communicate with each other over the backhaul links 114 (e.g., via an X2, Xn, or another network interface). In some implementations, the base stations 102 may communicate with each other directly (e.g., between the base stations 102). In some other implementations, the base stations 102 may communicate with each other indirectly (e.g., via the core network 106). In some implementations, one or more base stations 102 may include subcomponents, such as an access network entity, which may be an example of an access node controller (ANC). The ANC may communicate with the one or more UEs 104 through one or more other access network transmission entities, which may be referred to as remote radio heads, smart radio heads, gateways, transmission-reception points (TRPs), and other network nodes and/or entities.

The core network 106 may support user authentication, access authorization, tracking, connectivity, and other access, routing, or mobility functions. The core network 106 may be an evolved packet core (EPC), or a 5G core (5GC), which may include a control plane entity that manages access and mobility (e.g., a mobility management entity (MME), an access and mobility management functions (AMF)), and a user plane entity that routes packets or interconnects to external networks (e.g., a serving gateway (S-GW), a Packet Data Network (PDN) gateway (P-GW), or a user plane function (UPF)). In some implementations, the control plane entity may manage non-access stratum (NAS) functions, such as mobility, authentication, and bearer management for the one or more UEs 104 served by the one or more base stations 102 associated with the core network 106.

According to implementations, one or more of a device 116 (e.g., a network entity) and a sidelink device 118 are operable to implement various aspects of sidelink positioning measurement procedures, as described herein. Either of the device 116 and/or the sidelink device 118 may be implemented in the wireless communications system 100 as a UE 104, a base station 102, a roadside unit, an anchor UE, a target UE, a reference UE, a location server, an unmanned or uncrewed ariel vehicle (UAV) (e.g., a drone), and/or as any other type of network devices or entities performing procedures for sidelink positioning measurement. For instance, the device 116 can communicate (e.g., transmit) a measurement window configuration 120 to the sidelink device 118 via a sidelink communication link 112. In various implementations, the measurement window configuration 120 may be a sidelink measurement window configuration, a joint Uu and sidelink measurement window configuration, a measurement window configuration as part of a response time, a common measurement window configuration, or a measurement window configuration set. The sidelink device 118 receives the measurement window configuration 120 from the device 116 and performs sidelink positioning measurements based on the received sidelink measurement window configuration. Accordingly, the sidelink device 118 generates a response of the sidelink positioning measurements 122 for the sidelink device 118, and the sidelink positioning measurements 122 are communicated (e.g., transmitted) back to the device 116.

With reference to new radio (NR) positioning based on NR Uu signals and SA architecture (e.g., beam-based transmissions), the target use cases also include commercial and regulatory (emergency services) scenarios. The 3GPP (release 17) defines the positioning performance requirements for commercial and IIoT use cases. For example, the positioning error requirement for end-to-end latency for a position estimate of a UE in a commercial use case is less than 100 ms, and in an IIoT use case is less than 100 ms, within the order of 10 ms being desired. However, these positioning performance requirements do not address obtaining a position estimate for a UE based on sidelink PRS.

The supported positioning techniques (release 16) are listed in Table T1, and separate positioning techniques can be currently configured and performed based on the requirements of the location management function (LMF) and UE capabilities. The transmission of PRS enable the UE to perform UE positioning-related measurements to enable the computation of a UE's location estimate and are configured per transmission reception point (TRP), where a TRP may transmit one or more beams. Various RAT-dependent positioning techniques (also referred to as positioning methods, or positioning procedures) are supported for a UE, for UE-assisted, LMF-based, and/or for NG-RAN node assisted. The RAT-dependent positioning techniques that are supported include downlink-time difference of arrival (DL-TDOA), downlink-angle of departure (DL-AoD), multi-round trip time (multi-RTT), new radio enhanced cell-ID (NR E-CID); uplink-time difference of arrival (UL-TDOA); and uplink-angle of arrival (UL-AoA).

TABLE T1
Supported Rel-16 UE Positioning Methods

| | | UE-assisted, | NG-RAN node | |
|---|---|---|---|---|
| Method | UE-based | LMF-based | assisted | SUPL |
| A-GNSS | Yes | Yes | No | Yes (UE-based and UE-assisted) |
| OTDOA ^{Note1, Note 2} | No | Yes | No | Yes (UE-assisted) |
| E-CID ^{Note 4} | No | Yes | Yes | Yes for E-UTRA (UE-assisted) |
| Sensor | Yes | Yes | No | No |
| WLAN | Yes | Yes | No | Yes |
| Bluetooth | No | Yes | No | No |
| TBS ^{Note 5} | Yes | Yes | No | Yes (MBS) |
| DL-TDOA | Yes | Yes | No | No |
| DL-AoD | Yes | Yes | No | No |
| Multi-RTT | No | Yes | Yes | No |
| NR E-CID | No | Yes | FFS | No |
| UL-TDOA | No | No | Yes | No |
| UL-AoA | No | No | Yes | No |

^{Note}
¹ This includes TBS positioning based on PRS signals.
^{Note}
² In this version of the specification only OTDOA based on LTE signals is supported.
^{Note}
³ Void.
^{Note}
⁴ This includes Cell-ID for NR method.
^{Note}
⁵ In this version of the specification only for TBS positioning based on MBS signals.
^{Note}
⁶ Void

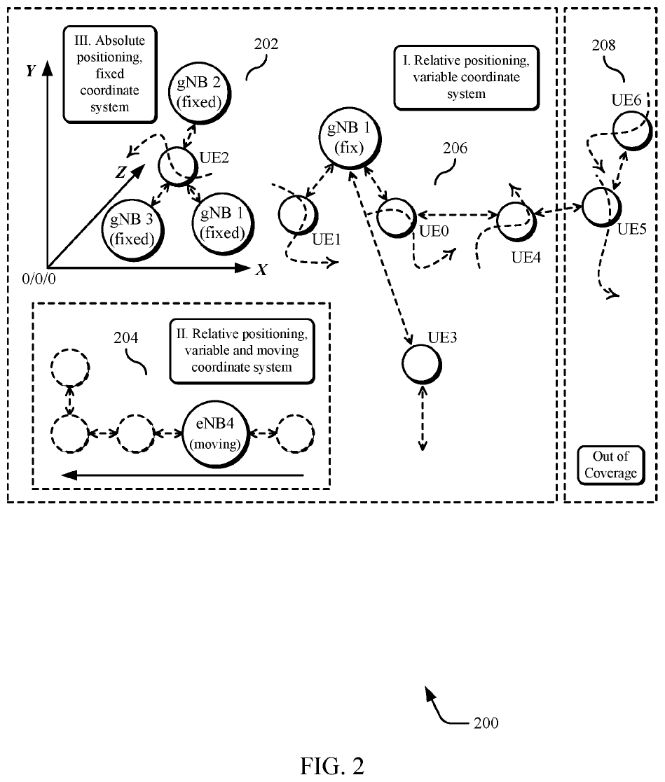

FIG. 2 illustrates an example 200 of absolute and relative positioning scenarios as related to sidelink positioning measurement procedures in accordance with aspects of the present disclosure. The network devices described with reference to example 200 may use and/or be implemented with the wireless communications system 100 and include UEs 104 and base stations 102 (e.g., eNB, gNB). The example 200 is an overview of absolute and relative positioning scenarios as defined in the architectural (stage 1) specifications using three different co-ordinate systems, including (III) a conventional absolute positioning, fixed coordinate system at 202; (II) a relative positioning, variable and moving coordinate system at 204; and (I) a relative positioning, variable coordinate system at 206. Notably, the relative positioning, variable coordinate system at 206 is based on relative device positions in a variable coordinate system, where the reference may be always changing with the multiple nodes that are moving in different directions. The example 200 also includes a scenario 208 for an out of coverage area in which UEs need to determine relative position with respect to each other.

With reference to RAT-dependent positioning techniques, the DL-TDOA positioning technique utilizes at least three network nodes for positioning based on triangulation. The DL-TDOA positioning method makes use of the downlink reference signal time difference (RSTD) (and optionally DL PRS RSRP) of downlink signals received from multiple transmission points (TPs) at the UE. The UE measures the downlink RSTD (and optionally DL PRS RSRP) of the received signals using assistance data received from the positioning server (also referred to herein as the location server), and the resulting measurements are used along with other configuration information to locate the UE in relation to the neighboring TPs.

The DL-AoD positioning technique makes use of the measured downlink PRS reference signal received power (RSRP) (DL PRS RSRP) of downlink signals received from multiple TPs at the UE. The UE measures the DL PRS RSRP of the received signals using assistance data received from the positioning server (also referred to herein as the location server), and the resulting measurements are used along with other configuration information to locate the UE in relation to the neighboring TPs.

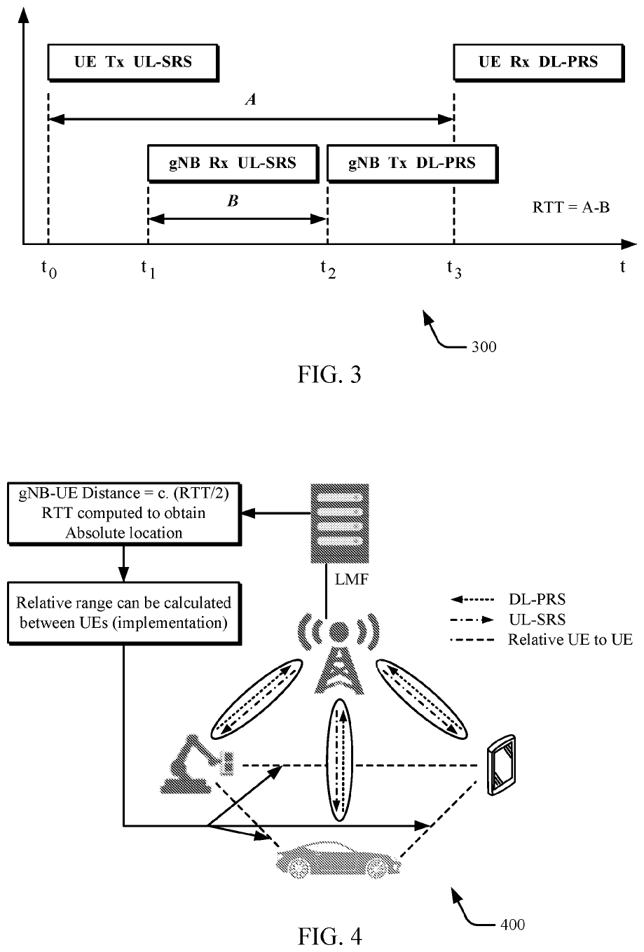

FIG. 3 illustrates an example 300 of a multi-cell RTT procedure as related to sidelink positioning measurement procedures in accordance with aspects of the present disclosure. The multi-RTT positioning technique makes use of the UE Rx-Tx measurements and DL PRS RSRP of downlink signals received from multiple TRPs, as measured by the UE and the measured gNB Rx-Tx measurements and uplink sounding reference signal (SRS) RSRP (UL SRS-RSRP) at multiple TRPs of uplink signals transmitted from UE. The UE measures the UE Rx-Tx measurements (and optionally DL PRS RSRP of the received signals) using assistance data received from the positioning server (also referred to herein as the location server), and the TRPs the gNB Rx-Tx measurements (and optionally UL SRS-RSRP of the received signals) using assistance data received from the positioning server. The measurements are used to determine the RTT at the positioning server, which are used to estimate the location of the UE. The multi-RTT is only supported for UE-assisted and NG-RAN assisted positioning techniques as noted in Table T1.

FIG. 4 illustrates an example of a system 400 for existing relative range estimation as related to sidelink positioning measurement procedures in accordance with aspects of the present disclosure. The system 400 illustrates the relative range estimation using the existing single gNB RTT positioning framework. The location server (LMF) can configure measurements to the different UEs, and then the target UEs can report their measurements in a transparent way to the location server. The location server can compute the absolute location, but in order to get the relative distance between two of the UEs, it would need prior information, such as the locations of the target UEs.

For the NR enhanced cell ID (E-CID) positioning technique, the position of a UE is estimated with the knowledge of its serving ng-eNB, gNB, and cell, and is based on LTE signals. The information about the serving ng-eNB, gNB, and cell may be obtained by paging, registration, or other methods. The NR enhanced cell-ID (NR E-CID) positioning refers to techniques which use additional UE measurements and/or NR radio resources and other measurements to improve the UE location estimate using NR signals. Although enhanced cell-ID (E-CID) positioning may utilize some of the same measurements as the measurement control system in the radio resource control (RRC) protocol, the UE may not make additional measurements for the sole purpose of positioning (i.e., the positioning procedures do not supply a measurement configuration or measurement control message, and the UE reports the measurements that it has available rather than being required to take additional measurement actions).

The uplink time difference of arrival (UL-TDOA) positioning technique makes use of the UL-TDOA (and optionally UL SRS-RSRP) at multiple reception points (RPs) of uplink signals transmitted from UE. The RPs measure the UL-TDOA (and optionally UL SRS-RSRP) of the received signals using assistance data received from the positioning server, and the resulting measurements are used along with other configuration information to estimate the location of the UE. The uplink angle of arrival (UL-AoA) positioning technique makes use of the measured azimuth and the zenith of arrival at multiple RPs of uplink signals transmitted from UE. The RPs measure azimuth-AoA and zenith-AoA of the received signals using assistance data received from the positioning server (also referred to herein as the location server), and the resulting measurements are used along with other configuration information to estimate the location of the UE.

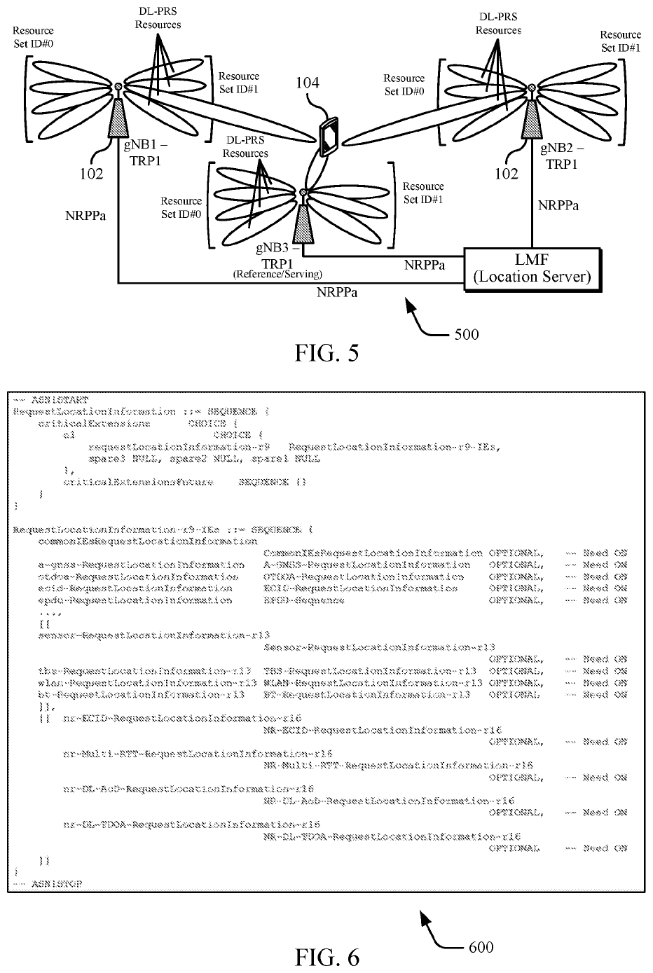

FIG. 5 illustrates an example of a system 500 for NR beam-based positioning as related to sidelink positioning measurement procedures in accordance with aspects of the present disclosure. The system 500 illustrates a UE 104 and base stations 102 (e.g., gNB). The PRS can be transmitted by different base stations (serving and neighboring) using narrow beams over FR1 and FR2 as illustrated in the example system 500, which is relatively different when compared to LTE where the PRS was transmitted across the whole cell. The PRS can be locally associated with a PRS Resource ID and Resource Set ID for a base station (TRP). Similarly, UE positioning measurements such as Reference Signal Time Difference (RSTD) and PRS RSRP measurements are made between beams (e.g., between a different pair of DL PRS resources or DL PRS resource sets) as opposed to different cells as was the case in LTE. In addition, there are additional UL positioning methods for the network to exploit in order to compute the target UE's location.

The Tables T2 and T3 show the reference signal to measurements mapping for each of the supported RAT-dependent positioning techniques at the UE and gNB, respectively.

TABLE T2
UE measurements to enable RAT-dependent positioning techniques.

| | | To facilitate support of |
|---|---|---|
| DL/UL Reference Signals | UE Measurements | the positioning techniques |
| Rel. 16 DL PRS | DL RSTD | DL-TDOA |
| Rel. 16 DL PRS | DL PRS RSRP | DL-TDOA, DL-AOD, |
| | | Multi-RTT |
| Rel.16 DL PRS / Rel. 16 | UE Rx-Tx time difference | Multi-RTT |
| SRS for positioning | | |
| Rel. 15 SSB / CSI-RS for | SS-RSRP(RSRP for RRM), | NR E-CID |
| RRM | SS-RSRQ(for RRM), CSI- | |
| | RSRP (for RRM), CSI- | |
| | RSRQ (for RRM), SS- | |
| | RSRPB (for RRM) | |

TABLE T3
gNB measurements to enable RAT-dependent positioning techniques.

| DL/UL Reference | | To facilitate support of |
|---|---|---|
| Signals | gNB Measurements | the positioning techniques |
| Rel. 16 SRS for | UL RTOA | UL-TDOA |
| positioning | | |
| Rel.16 SRS for | UL SRS-REFERENCE | UL-TDOA, UL-AoA, Multi- |
| positioning | SIGNAL RECEIVED | RTT |
| | POWER (RSRP) | |
| Rel.16 SRS for | gNB Rx-Tx time | Multi-RTT |
| positioning, Rel. 16 DL | difference | |
| PRS | | |
| Rel.16 SRS for | AoA and ZoA | UL-AoA, Multi-RTT |
| positioning | | |

The RAT-dependent positioning techniques may utilize the 3GPP RAT and core network entities to perform the position estimation of the UE, which are differentiated from RAT-independent positioning techniques, which rely on GNSS, IMU sensor, WLAN, and Bluetooth technologies for performing target device (UE) positioning. Network-assisted GNSS methods make use of UEs that are equipped with radio receivers capable of receiving GNSS signals. In 3GPP specifications the term GNSS encompasses both global and regional/augmentation navigation satellite systems. Examples of global navigation satellite systems include GPS, Modernized GPS, Galileo, GLONASS, and BeiDou Navigation Satellite System (BDS). Regional navigation satellite systems include Quasi Zenith Satellite System (QZSS) while the many augmentation systems, are classified under the generic term of Space Based Augmentation Systems (SBAS) and provide regional augmentation services. Different GNSSs (e.g. GPS, Galileo, etc.) can be used separately or in combination to determine the location of a UE.

Barometric pressure sensor positioning makes use of barometric sensors to determine the vertical component of the position of the UE. The UE measures barometric pressure, optionally aided by assistance data, to calculate the vertical component of its location or to send measurements to the positioning server for position calculation. This method can be combined with other positioning methods to determine the 3D position of the UE. WLAN positioning makes use of the WLAN measurements (access point (AP) identifiers and optionally other measurements) and databases to determine the location of the UE. The UE measures received signals from WLAN access points, optionally aided by assistance data, to send measurements to the positioning server for position calculation. Using the measurement results and a references database, the location of the UE is calculated. Additionally or alternatively, the UE makes use of WLAN measurements and optionally WLAN AP assistance data provided by the positioning server, to determine its location.

Bluetooth positioning makes use of Bluetooth measurements (beacon identifiers and optionally other measurements) to determine the location of the UE. The UE measures received signals from Bluetooth beacons. Using the measurement results and a references database, the location of the UE 104 is calculated. The Bluetooth methods may be combined with other positioning methods (e.g., WLAN) to improve positioning accuracy of the UE. TBS positioning consists of a network of ground-based transmitters, broadcasting signals only for positioning purposes. The current type of TBS positioning signals are the MBS (Metropolitan Beacon System) signals and Positioning Reference Signals (PRS). The UE measures received TBS signals, optionally aided by assistance data, to calculate its location or to send measurements to the positioning server for position calculation. Motion sensor positioning makes use of different sensors such as accelerometers, gyros, magnetometers, to calculate the displacement of UE 104. The UE 104 estimates a relative displacement based upon a reference position and/or reference time. The UE 104 sends a report comprising the determined relative displacement which can be used to determine the absolute position. This method can be used with other positioning methods for hybrid positioning.

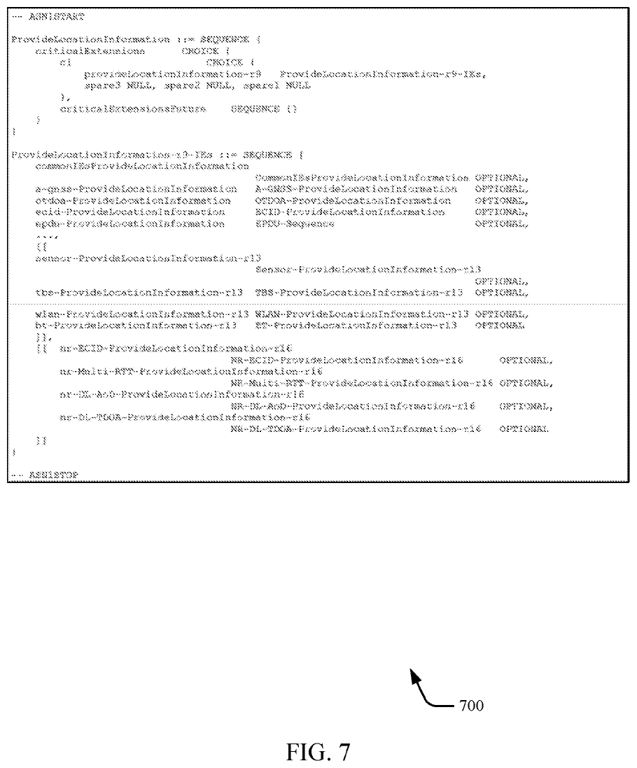

With reference to a conceptual overview of the current Uu implementation (release 16), the overall measurement configuration and reporting is performed per configured RAT-dependent positioning method and/or RAT-independent positioning method. FIG. 6 illustrates an example 600 of a LTE positioning protocol (LPP) request location information (RequestlocationInformation) message as related to sidelink positioning measurement procedures, as described herein. The RequestlocationInformation message body in a LPP message is used by the location server to request positioning measurements or a position estimate from the target device. FIG. 7 illustrates an example 700 of a LPP provide location information (ProvidelocationInformation) message as related to sidelink positioning measurement procedures, as described herein. The ProvideLocationInformation message body in a LPP message is used by the target device to provide positioning measurements or position estimates to the location server.

With reference to RAT-dependent positioning measurements, the different downlink measurements, including DL PRS RSRP, downlink RSTD, and UE Rx-Tx time difference required for the supported RAT-dependent positioning techniques are shown in Table T4. The measurement configurations may include four (4) pair of downlink RSTD measurements performed per pair of cells, and each measurement is performed between a different pair of downlink PRS resources or resource sets with a single reference timing; and eight (8) downlink PRS reference signal received power (RSRP) measurements can be performed on different downlink PRS resources from the same cell.

TABLE T4
Downlink measurements for downlink-based positioning techniques.
DL PRS reference signal received power (DL PRS-RSRP)

| | |
|---|---|
| Definition | DL PRS-RSRP, is the linear average over the power contributions (in [W]) of |
| | the resource elements that carry DL PRS reference signals configured for |
| | RSRP measurements within the considered measurement frequency |
| | bandwidth. |
| | For frequency range 1, the reference point for the DL PRS-RSRP shall be the |
| | antenna connector of the UE. For frequency range 2, DL PRS-RSRP shall be |
| | measured based on the combined signal from antenna elements corresponding |
| | to a given receiver branch. For frequency range 1 and 2, if receiver diversity is |
| | in use by the UE, the reported DL PRS-RSRP value shall not be lower than |
| | the corresponding DL PRS-RSRP of any of the individual receiver branches. |
| Applicable for | RRC_CONNECTED intra-frequency, |
| | RRC_CONNECTED inter-frequency |

DL reference signal time difference (DL RSTD)

| | |
|---|---|
| Definition | DL reference signal time difference (DL RSTD) is the DL relative timing |
| | difference between the positioning node j and the reference positioning node i, |
| | defined as T_{SubframeRxj} − T_{SubframeRxi}, |
| | Where: |
| | T_{SubframeRxj} is the time when the UE receives the start of one subframe from |
| | positioning node j. |
| | T_{SubframeRxi} is the time when the UE receives the corresponding start of one |
| | subframe from positioning node i that is closest in time to the subframe |
| | received from positioning node j. |
| | Multiple DL PRS resources can be used to determine the start of one subframe |
| | from a positioning node. |
| | For frequency range 1, the reference point for the DL RSTD shall be the |
| | antenna connector of the UE. For frequency range 2, the reference point for |
| | the DL RSTD shall be the antenna of the UE. |
| Applicable for | RRC_CONNECTED intra-frequency |
| | RRC_CONNECTED inter-frequency |

UE Rx − Tx time difference

| | |
|---|---|
| Definition | The UE Rx − Tx time difference is defined as TUE-RX − TUE-TX |
| | Where: |
| | TUE-RX is the UE received timing of downlink subframe #i from a positioning |
| | node, defined by the first detected path in time. |
| | TUE-TX is the UE transmit timing of uplink subframe #j that is closest in time to |
| | the subframe #i received from the positioning node. |
| | Multiple DL PRS resources can be used to determine the start of one subframe |
| | of the first arrival path of the positioning node. |
| | For frequency range 1, the reference point for TUE-RX measurement shall be the |
| | Rx antenna connector of the UE and the reference point for TUE-TX |
| | measurement shall be the Tx antenna connector of the UE. For frequency |
| | range 2, the reference point for TUE-RX measurement shall be the Rx antenna of |
| | the UE and the reference point for TUE-TX measurement shall be the Tx antenna |
| | of the UE. |
| Applicable for | RRC_CONNECTED intra-frequency |
| | RRC_CONNECTED inter-frequency |

Aspects of the present disclosure include performing measurement and processing of sidelink positioning reference signals, supporting different SL-enabled UEs that may have different processing capabilities ranging from basic to advanced devices. This disclosure details solutions to support SL (PC5) positioning measurement and configurations related to a UE's sidelink positioning processing capabilities and UL resource availability to support absolute and relative positioning in a variety of latency, accuracy, and coverage scenarios. The described sidelink positioning measurement procedures include an implementation to configure a sidelink measurement window for performing sidelink measurements for positioning calculation, time drift correction, joint Uu and SL positioning measurements, deferred location measurement, and computation and groupcast sidelink positioning. The sidelink positioning measurement procedures also include an implementation to support the measurement configuration in different coverage scenarios, including in-coverage, partial coverage, and out-of-coverage. The sidelink positioning measurement procedures also include an implementation to configure the reporting of the sidelink positioning measurements based on the measurement window configuration. The sidelink positioning measurement procedures also include an implementation to configure an expected reference signal time difference (RSTD) window for SL-time difference of arrival (TDOA) for the same and different sidelink positioning frequency layers.

In terms of the described techniques, an initiator device initiates a sidelink positioning and ranging session, and a responder device responds to the sidelink positioning and ranging session from the initiator device. Further, the described implementations for sidelink positioning measurement procedures may be implemented in combination to support NR RAT-independent positioning over the sidelink (PC5) interface. In this disclosure, a positioning-related reference signal may be referred to as a reference signal used for positioning procedures and/or purposes in order to estimate a target-UE's location, such as based on positioning reference signals (PRS), or based on existing reference signals, such as a channel state information reference signal (CSI-RS) or a sounding reference signal (SRS). A target-UE may be referred to as the device or network entity to be localized or positioned. In implementations, the term PRS can refer to any signal, such as a reference signal, which may or may not be used primarily for positioning. A target-UE may also be referred to as a UE of interest, having a position (absolute or relative) that is to be obtained by the network or by the UE itself. Notably, any aspects of the positioning techniques described in this disclosure may be implemented in combination with any additional aspects of the positioning techniques described in the related disclosure: U.S. Patent Application No. 63/307,463 entitled “Sidelink Positioning Reference Signal Processing” filed Feb. 7, 2022 (docket no. SMM920210193-US-PSPF).

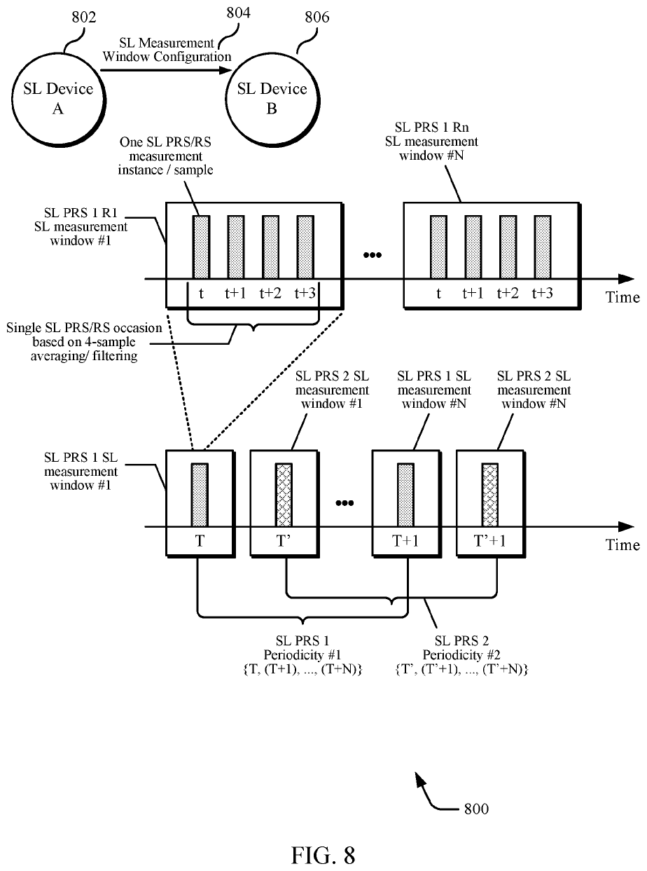

FIG. 8 illustrates an example 800 of sidelink measurement window configuration that supports sidelink positioning measurement procedures in accordance with aspects of the present disclosure. In implementations, a sidelink capable device or network entity may configure a UE with a sidelink positioning measurement window in which to perform sidelink positioning measurements for the purposes of absolute and relative positioning determination. Due to the mobility challenges of tracking a moving target-UE, the sidelink positioning measurement window can serve as a reference window relative to a time instance in which the actual positioning measurements are performed on the device side.

In an implementation, the sidelink positioning measurement window can be configured for one or more functions or scenarios. For instance, the sidelink positioning measurement window can be configured to enable the positioning calculation entity to correct for time drifts over time on a granular and/or resource level that may occur at a network node during the measurement of one or more sidelink PRS and/or other sidelink RS occasions or instances. A sidelink PRS or RS occasion may be one instance of periodically transmitted resources for the purposes of absolute or relative positioning. Further, an instance of sidelink PRS or RS may be averaged over X-number of samples, which may be based on a provided configuration. This would imply that a measurement of a sidelink PRS or RS instance for positioning may be averaged over X-samples for better accuracy in challenging wireless channel conditions subject to variations and fading. The example 800 illustrates the concept, where a sidelink device A 802 is an initiator device (e.g., configuring device) that configures the sidelink measurement window configuration 804, which is communicated (e.g., transmitted) to a sidelink device B 806. In this implementation, any timing drifts for each of the samples may be calculated with respect to the measurement window, enabling the position calculation entity (e.g., SL Device B 806) to compensate for the timing errors.

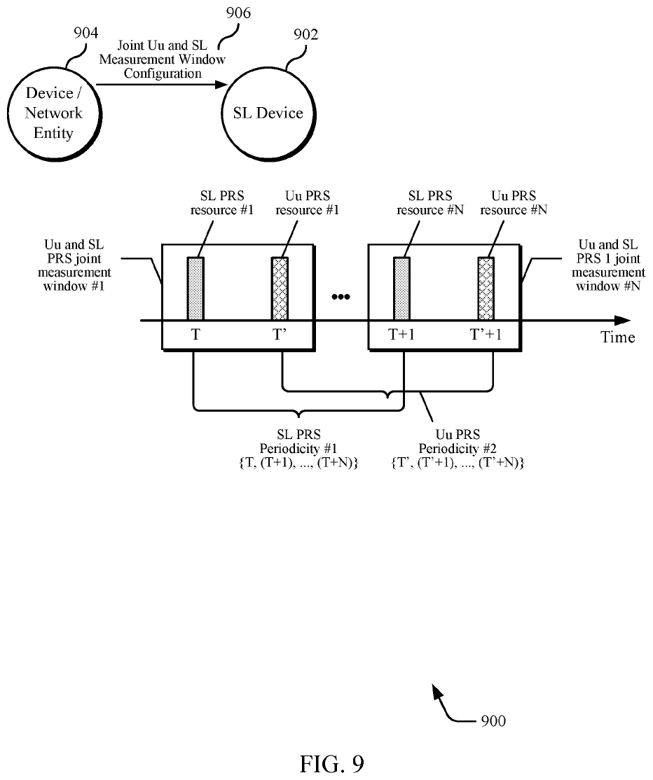

FIG. 9 illustrates an example 900 of joint Uu and sidelink positioning measurement window configuration that supports sidelink positioning measurement procedures in accordance with aspects of the present disclosure. The sidelink positioning measurement window can be configured to enable a defined time interval in which the device (e.g., target-UE 902) may jointly perform both Uu (downlink and/or uplink) and sidelink measurements, especially for in-coverage and partial coverage scenarios. Depending on the configuration, the Uu and SL positioning configuration may or may not share the same positioning frequency layer, as well as may or may not be measured within a measurement gap. This may be applicable to both RAT-independent and RAT-dependent positioning measurements.

The example 900 illustrates the concept, where one of the device 902 (e.g. a UE) or a network entity 904 (e.g. gNB or LMF) is the initiator device (e.g., configuring device) configuring the joint Uu and sidelink measurement window configuration 906. According to this implementation, the joint Uu and SL PRS measurement window can be configured to jointly correct any timing drifts for both Uu and SL PRS, which may be calculated with respect to the joint Uu and SL measurement window, enabling the position calculation entity to compensate for any timing errors. An example of a Uu measurement may include the measurement of a DL-based positioning measurement (e.g. UE Rx-Tx time difference), DL-AoD together with SL-based positioning measurement (e.g. SL-RTT, SL-TDOA, or the like). The joint measurement window can also assist in aligning both Uu and SL positioning measurements (e.g. via associated time stamps such that they may be consolidated via a single measurement report.

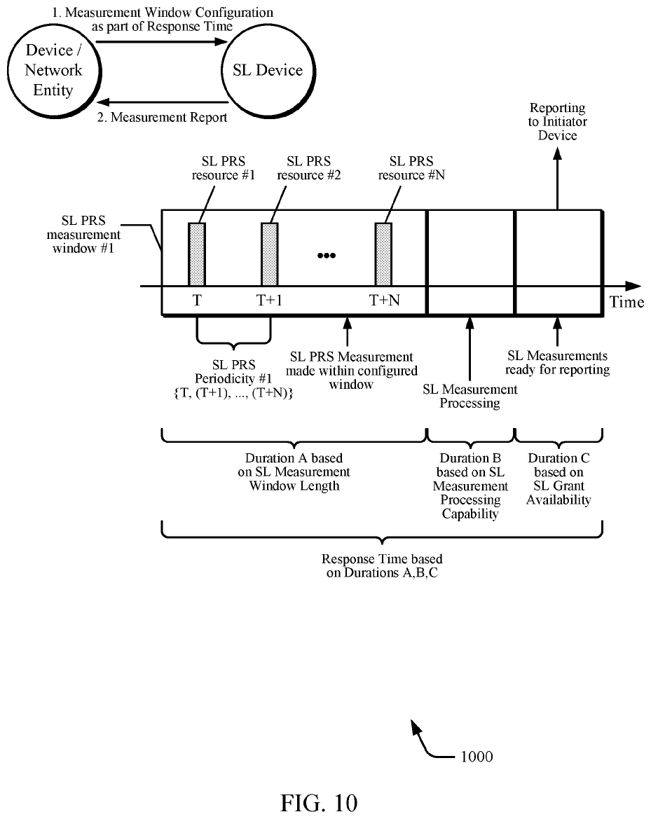

FIG. 10 illustrates an example 1000 of a measurement window configuration as part of response time signaling that supports sidelink positioning measurement procedures in accordance with aspects of the present disclosure. The sidelink positioning measurement window can be configured to enable a pre-defined or deferred time instance in which a sidelink node should commence or trigger the actual sidelink positioning measurements. This can be triggered in an on-demand manner or be based on a pre-configuration. This may also be part of a response time, in which the sidelink enabled node or device is expecting the positioning measurement or location estimate report within a configured response time.

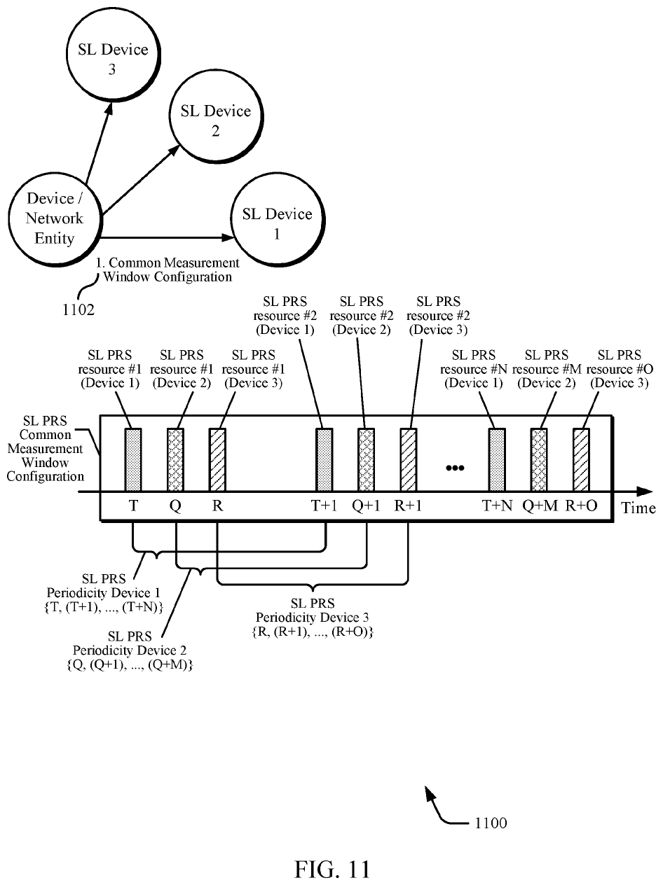

FIG. 11 illustrates an example 1100 of a common measurement window configuration for groupcast positioning that supports sidelink positioning measurement procedures in accordance with aspects of the present disclosure. In a sidelink groupcast positioning scenario, a sidelink measurement window can be configured for a common reference time interval in which all group members may perform positioning measurements within a certain defined interval, where the positioning measurements are reported based on a measurement. The example 1100 illustrates the concept, where a common measurement window configuration 1102 is configured for multiple member UEs in a groupcast positioning session.

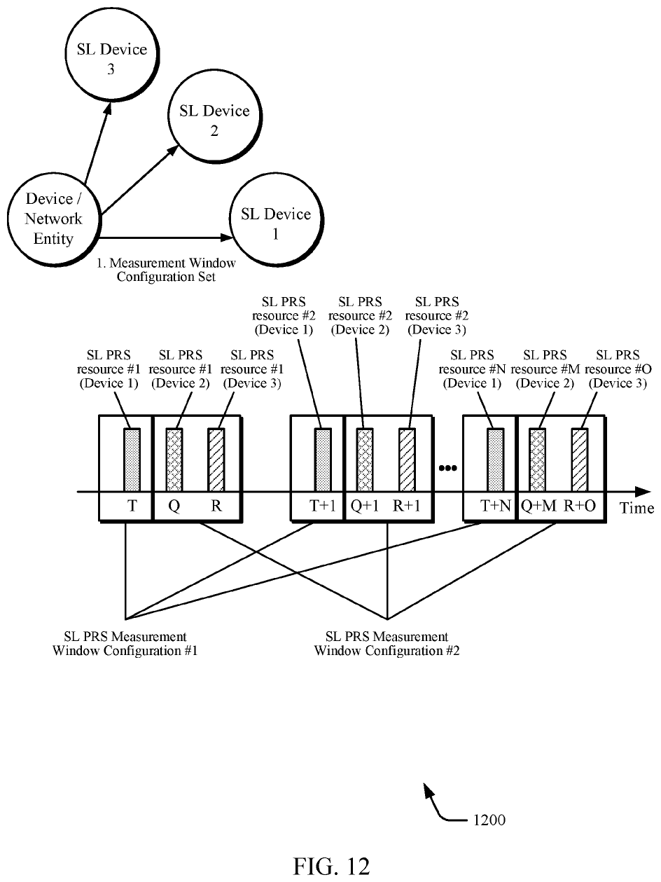

FIG. 12 illustrates an example 1200 of a separate measurement window configuration for groupcast positioning that supports sidelink positioning measurement procedures in accordance with aspects of the present disclosure. In another sidelink groupcast positioning scenario, separate measurement windows may be configured for a subset of one or more UEs, in which positioning measurements are to be performed. The example 1200 illustrates the concept, where separate measurement windows may be configured for different member UEs in a groupcast positioning session.

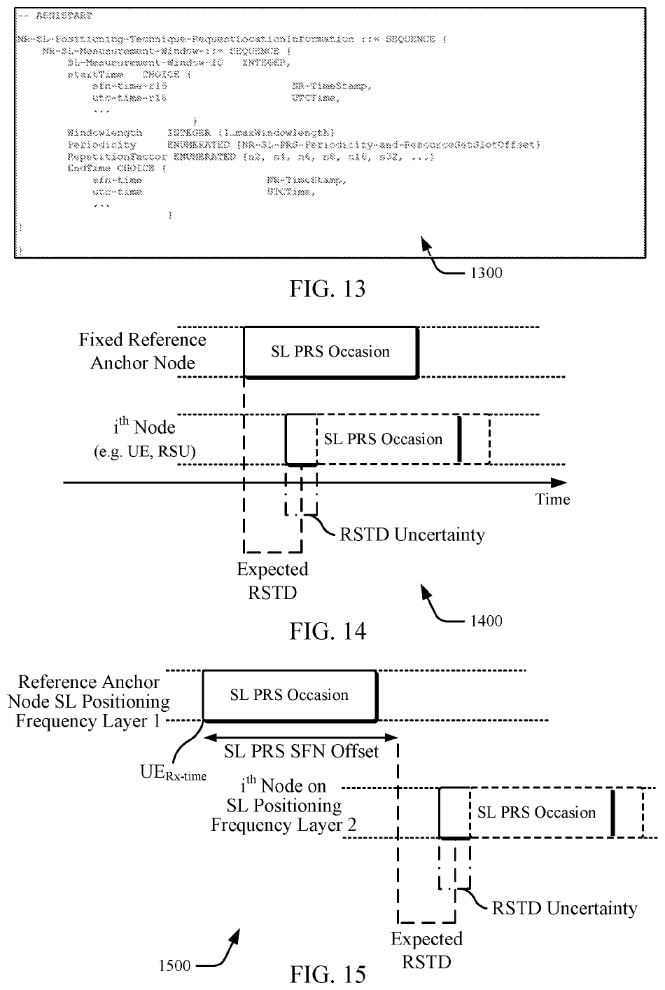

FIG. 13 illustrates an example 1300 of a sidelink positioning configuration that supports sidelink positioning measurement procedures in accordance with aspects of the present disclosure. In implementations, the sidelink measurement window configuration can include configuration information, such as a start time (e.g., relative to SFN 0), a window length, an end time, and a periodicity or repetition factor (number of repetitions of a sidelink PRS transmission). Each measurement window may be associated with a measurement window identifier (ID) to distinguish the different measurement windows from the same and/or different UEs and devices. In an implementation, the end time of the measurement window may be implicitly known based on the sidelink PRS configuration and/or start time and measurement window length.

In another implementation, the measurement window configuration may include the number of measurement samples to be averaged for each sidelink measurement instance, such as shown and described with reference to FIG. 8. Alternatively, the measurement samples associated for a particular sidelink positioning measurement may also be separately signaled as part of a separate measurement (pre-) configuration. The overall sidelink measurement window may be signaled and/or configured using broadcast signaling (e.g. via groupcast messages, positioning SIBs, V2X SIBs, or the like), or dedicated PC5 RRC/RRC/MAC CE/LPP signaling. The measurement window can be periodical based on the measurement of periodical SL PRS resources, or can be dynamically configured for one shot measurements. The measurement window may be configured per sidelink positioning technique and/or based on a common configuration that may be applicable to multiple UEs irrespective of the positioning technique.

The example 1300 illustrates an example signaling extract that may define the measurement window per sidelink positioning technique. This configuration may be signaled via assistance data and/or measurement configuration for sidelink positioning. The start time can be expressed in terms of SFN or UTC time standards. In another implementation, multiple measurement IDs can be further associated to multiple measurement windows, which form part of larger index or list based on the amount of SL PRS measurements instances (and corresponding amount of SL PRS resources).

The sidelink measurement window configuration can be supported in several implementation scenarios. In a first scenario for a UE-based, UE-configured measurement window, a UE supporting sidelink positioning performs RAT-dependent and/or RAT-independent measurements based on a measurement window configuration provided by another UE or device (e.g., an anchor UE, a reference UE, target-UEs, a roadside unit, or the like). In this scenario, the absolute and/or relative positioning calculation entity may be the UE receiving the measurement reports based on the provided measurement window configuration. Alternatively, the measurement window may be based on a pre-configuration and/or system information from a previously visited cell or RAN notification area.

In a second scenario for a UE-based network configured measurement window, a UE supporting sidelink positioning performs RAT-dependent and/or RAT-independent measurements based on a measurement window configuration provided by one or more network entities, such as a base station (e.g., gNB), a location server, a reference station, a reference TRP, roadside units, via positioning assistance data, or measurement configuration signaling. In this scenario, the absolute and/or relative positioning calculation entity may be the UE receiving the measurement reports based on the provided network measurement window configuration.

In a third scenario for a UE-assisted, UE-configured measurement window, a UE supporting sidelink positioning performs RAT-dependent and/or RAT-independent measurements based on a measurement window configuration provided by another UE or device (e.g., an anchor UE, a reference UE, target-UEs, or the like). In this scenario, the absolute and/or relative positioning calculation entity may be a network entity receiving the measurement reports based on the provided measurement window configuration from a base station (e.g., gNB), a location server, a reference station, a reference TRP, and/or roadside units, and the like. Alternatively, the measurement window may be based on a pre-configuration and/or system information from a previously visited cell or RAN notification area.

In a fourth scenario for a UE-assisted network configured measurement window, a UE supporting sidelink positioning performs RAT-dependent and/or RAT-independent measurements based on a measurement window configuration provided by one or more network entities, such as a base station (e.g., gNB), a location server, a reference station, a reference TRP, roadside units, via positioning assistance data, or measurement configuration signaling. In this scenario, the absolute and/or relative positioning calculation entity may be a network entity receiving the measurement reports based on the provided measurement window configuration from a base station (e.g., gNB), a location server, a reference station, a reference TRP, and/or roadside units, and the like.

In implementations, the processing UE or device (e.g., responding device) reports back to the initiating UE or device (e.g., configuring device). The UE or device configured with the sidelink positioning measurement window may report the SL RAT-dependent or RAT-independent positioning measurements based on the associated measurement window ID for easier tracking and management of received measurements at the positioning calculation entity. In the groupcast sidelink positioning scenario, different member UEs may report their own positioning measurements based on the common measurement window ID, or separate measurement window IDs. Alternatively, the UE or device may prioritize measurements performed in the configured measurement window, when compared to measurements made outside the window. Further, measurements made outside of the window may be dropped from the positioning measurement report. In an implementation, the UE or device may perform sidelink measurements both inside and outside the measurement window in a best effort manner and report all the measurements to the positioning calculation entity. Further, the reporting pre-configuration of the measurement window may be overridden by an updated broadcast signal, such as positioning or V2X SIBs received when entering a new cell or RAN notification area. The preconfigured measurement window may also be overridden using a dedicated assistance data and/or configuration signaling received from another UE, device, or other network entity.

FIG. 14 illustrates an example 1400 of an adapted RSTD search window for performing sidelink TDOA on a same sidelink positioning frequency layer, which supports sidelink positioning measurement procedures in accordance with aspects of the present disclosure. A sidelink RSTD search window can be implemented, in which the positioning calculation entity (e.g., a UE, device, or other network entity) anticipates or predicts a time interval of a certain duration in which to measure the time difference of two SL PRS transmissions from different nodes. Due to the decentralized and distributed nature of sidelink communications and positioning, it is important that the UE performing the SL RSTD measurement (TDOA) measurement be provided with an expected search window as additional assistance information. An information about the rough location of the target-UE is also beneficial in order to provide the expected SL RSTD search window.

The RSTD measurements used to compute the target-UE's location by using SL-TDOA will be impacted in terms of the expected RSTD configured by the positioning calculation entity via configuration signaling (e.g., sidelink positioning assistance data). The positioning calculation may derive this value based on a priori coarse location of the target-UE, which may be obtained by a method such as E-CID and/or SL RRM measurements, and may predict the expected RSTD value via a search window. This expected RSTD time resolution parameter indicates predicted RSTD measurement between the signals from at least two sidelink anchor nodes, referred to as a reference anchor node and a neighboring, secondary, or measured anchor node. The reference sidelink anchor node may include an RSU, UE, device, or the like. The expected RSTD field takes into account the propagation time difference and the transmit time difference of the different SL PRS occasions received between two sidelink nodes. Furthermore, the expected RSTD window and the associated RSTD uncertainty assists the measuring UE or device in understanding and obtaining a time instance, during which to expect the PRS occasion from a neighboring or secondary sidelink node. The RSTD uncertainty can be signaled as a confidence interval or error margin indicating the prediction quality of the expected sidelink RSTD window.

The example 1400 illustrates the concept of the adapted RSTD search window for performing SL TDOA on the same sidelink positioning frequency layer. First, the target UE obtains a timing from the reference anchor node. Then, the measuring device or UE obtains a PRS occasion for a secondary anchor node, referred to as the i^{th} node in this example, based on the timing obtained from the reference anchor node and the computed expected RSTD. Then, the measuring UE or device computes the actual RSTD, which should be within the expected RSTD window already signaled to the UE or other device. For the case of the same sidelink positioning frequency layer, the sidelink expected RSTD search window may be set:

$$Expected SL RSTD Window = [ - Expected SL RSTD \times {T}_{s} \times R ; Expected SL RSTD \times {T}_{s} \times R ]$$

where the sampling time equals Tₛ=1/(Δfₘₐₓ λN_{FFT}). For example, Tₛ=1/(15 kHz×2048) and R is the required resolution factor.

FIG. 15 illustrates an example 1500 of an adapted RSTD search window for performing sidelink TDOA on different sidelink positioning frequency layers, which supports sidelink positioning measurement procedures in accordance with aspects of the present disclosure. The example 1500 illustrates the concept of the adapted RSTD search window for performing SL-TDOA on different sidelink positioning frequency layers. First, the target UE obtains a timing from the reference anchor node and is provided with SL PRS SFN offset with respect to the second PRS occasion. Then, the target UE obtains a sidelink PRS occasion for a secondary node, referred to as the i^{th} node in this example, based on the timing obtained from the reference anchor node and the computed expected RSTD. The measuring UE or device then computes the actual RSTD, which should be within the expected RSTD window already signaled to the UE or device.

For the case of different sidelink positioning frequency layers, the expected sidelink RSTD search window may be set:

$$Expected SL RSTD Window = [ - Expected SL RSTD \times {T}_{s} \times R ; Expected SL RSTD \times {T}_{s} \times R ]$$

centered at (UE_{Rx-Time}+ (1 ms×N_{SL-PRS-Off set})+Expected SL RSTD×Tₛ×R), where the sampling time equals Tₛ=1/(Δfₘₐₓ×N_{FFT}). For example, Tₛ=1/(15000×2048) for an sidelink positioning system with Δfₘₐₓ=15 kHz and N_{FFT}=2048 as the subcarrier spacing and FFT size, respectively. In some implementations, the subcarrier spacing may be associated with FR1 frequencies such as 30 kHz and 60 kHz, while in other implementations, the subcarrier spacing may be associated with FR2 frequencies such as 120 kHz, 240 kHz. The parameter N_{SL-PRS-Offset} may be configured and signaled by the positioning calculation entity providing the expected RSTD window. Resolution R may be fixed in the specification, configured or signaled by the network, determined by a UE implementation, or a combination thereof.

The sidelink expected RSTD window may be signaled using either broadcast signaling (e.g., via groupcast messages, positioning SIBs, V2X SIBs, or the like) or dedicated PC5 RRC/RRC/MAC CE/SL-LPP/LPP signaling. In another implementation, the expected RSTD may also be applied to existing sidelink RSs that may be used for positioning purposes for supporting SL-TDOA. In another implementation, the search window may be also extended to measure the sidelink positioning measurements at a certain predicted time, and these could be associated with other positioning techniques such as sidelink round trip time (RTT) (UE Rx-Tx time difference), sidelink angle-of-arrival (AoA), sidelink received signal strength (RSS) or sidelink radio resource management (RRM).

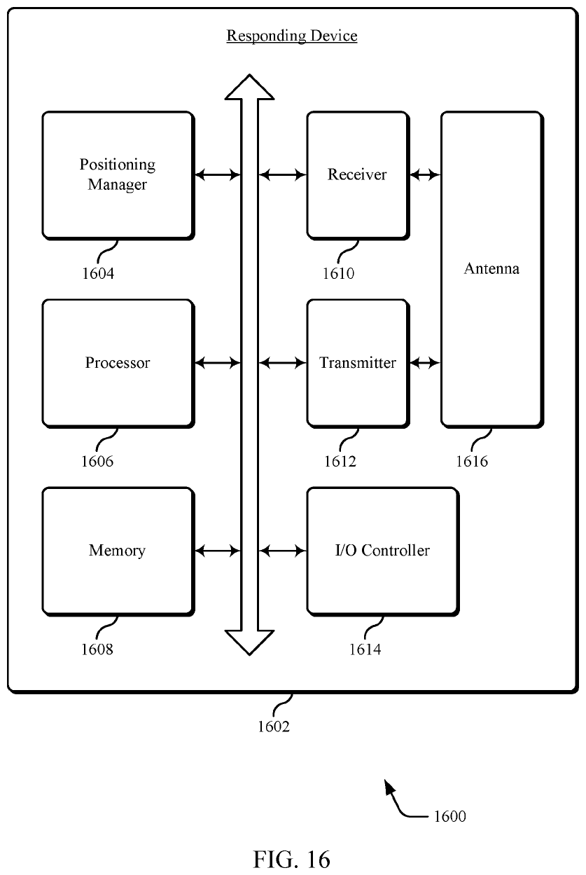

FIG. 16 illustrates an example of a block diagram 1600 of a device 1602 that supports sidelink positioning measurement procedures in accordance with aspects of the present disclosure. The device 1602 may be an example of a UE 104, such as a responding device, as described herein. The device 1602 may support wireless communication and/or network signaling with one or more base stations 102, other UEs 104, network entities and devices, or any combination thereof. The device 1602 may include components for bi-directional communications including components for transmitting and receiving communications, such as a positioning manager 1604, a processor 1606, a memory 1608, a receiver 1610, a transmitter 1612, and an I/O controller 1614. These components may be in electronic communication or otherwise coupled (e.g., operatively, communicatively, functionally, electronically, electrically) via one or more interfaces (e.g., buses).

The positioning manager 1604, the receiver 1610, the transmitter 1612, or various combinations thereof or various components thereof may be examples of means for performing various aspects of the present disclosure as described herein. For example, the positioning manager 1604, the receiver 1610, the transmitter 1612, or various combinations or components thereof may support a method for performing one or more of the functions described herein.

In some implementations, the positioning manager 1604, the receiver 1610, the transmitter 1612, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some implementations, the processor 1606 and the memory 1608 coupled with the processor 1606 may be configured to perform one or more of the functions described herein (e.g., by executing, by the processor 1606, instructions stored in the memory 1608).

Additionally or alternatively, in some implementations, the positioning manager 1604, the receiver 1610, the transmitter 1612, or various combinations or components thereof may be implemented in code (e.g., as communications management software or firmware) executed by the processor 1606. If implemented in code executed by the processor 1606, the functions of the positioning manager 1604, the receiver 1610, the transmitter 1612, or various combinations or components thereof may be performed by a general-purpose processor, a DSP, a central processing unit (CPU), an ASIC, an FPGA, or any combination of these or other programmable logic devices (e.g., configured as or otherwise supporting a means for performing the functions described in the present disclosure).

In some implementations, the positioning manager 1604 may be configured to perform various operations (e.g., receiving, monitoring, transmitting) using or otherwise in cooperation with the receiver 1610, the transmitter 1612, or both. For example, the positioning manager 1604 may receive information from the receiver 1610, send information to the transmitter 1612, or be integrated in combination with the receiver 1610, the transmitter 1612, or both to receive information, transmit information, or perform various other operations as described herein. Although the positioning manager 1604 is illustrated as a separate component, in some implementations, one or more functions described with reference to the positioning manager 1604 may be supported by or performed by the processor 1606, the memory 1608, or any combination thereof. For example, the memory 1608 may store code, which may include instructions executable by the processor 1606 to cause the device 1602 to perform various aspects of the present disclosure as described herein, or the processor 1606 and the memory 1608 may be otherwise configured to perform or support such operations.

For example, the positioning manager 1604 may support wireless communication and/or network signaling at a device (e.g., the device 1602, a UE) in accordance with examples as disclosed herein. The positioning manager 1604 and/or other device components may be configured as or otherwise support an apparatus, such as a UE as a responding device, including a transceiver; a processor coupled to the transceiver, the processor and the transceiver configured to cause the apparatus to: receive a sidelink measurement window configuration from a configuring device; perform sidelink positioning measurements based at least in part on the sidelink measurement window configuration; and transmit the sidelink positioning measurements for the apparatus to the configuring device.

Additionally, the apparatus (e.g., a UE) includes any one or combination of: the sidelink measurement window configuration includes multiple instances of sidelink positioning reference signals (PRS), and the sidelink positioning measurements are averaged over the multiple instances of the sidelink PRS. The sidelink measurement window configuration includes multiple instances of sidelink PRS, and the processor is configured to cause the apparatus to perform sidelink timing error mitigation based on one or more of the multiple instances of the sidelink PRS. The processor is configured to cause the apparatus to jointly perform the sidelink positioning measurements and one or more of downlink positioning measurements or uplink positioning measurements. The sidelink measurement window configuration includes multiple pre-defined time instances of sidelink PRS, and the processor is configured to cause the apparatus to compute at least one of absolute location information or relative location information for one or more of the multiple pre-defined time instances of the sidelink PRS. The sidelink measurement window configuration is a common configuration applicable to multiple responding devices, and the processor is configured to cause the apparatus to perform sidelink positioning measurements based at least in part on instances of sidelink PRS corresponding to the apparatus in the sidelink measurement window configuration. The sidelink measurement window configuration is one of user equipment (UE)-based, UE-configured; UE-based, network configured; UE-assisted, UE-configured; or UE-assisted, network configured. The sidelink measurement window configuration is associated with a measurement window identifier (ID), and the processor and the transceiver are configured to cause the apparatus to report the sidelink positioning measurements based at least in part on the measurement window ID. The processor and the transceiver are configured to cause the apparatus to receive a configuration of a sidelink expected reference signal time difference (RSTD) search window, and measure a sidelink RSTD within the sidelink expected RSTD search window. The apparatus comprises at least one of a roadside unit, an anchor UE, or one or more UE configured for sidelink positioning configuration and measurements. The processor is configured to cause the apparatus to prioritize the sidelink positioning measurements performed within the configured sidelink measurement window.

The positioning manager 1604 and/or other device components may be configured as or otherwise support a means for wireless communication and/or network signaling at a UE as a responding device, including receiving a sidelink measurement window configuration from a configuring device; performing sidelink positioning measurements based at least in part on the sidelink measurement window configuration; and transmitting the sidelink positioning measurements to the configuring device.

Additionally, wireless communication and/or network signaling at the UE includes any one or combination of: the sidelink measurement window configuration includes multiple instances of sidelink positioning reference signals (PRS), and the sidelink positioning measurements are averaged over the multiple instances of the sidelink PRS. The sidelink measurement window configuration includes multiple instances of sidelink PRS, and the method further comprising performing sidelink timing error mitigation based on one or more of the multiple instances of the sidelink PRS. The method further comprising jointly performing the sidelink positioning measurements and one or more of downlink positioning measurements or uplink positioning measurements. The sidelink measurement window configuration includes multiple pre-defined time instances of sidelink PRS, the method further comprising computing at least one of absolute location information or relative location information for one or more of the multiple pre-defined time instances of the sidelink PRS. The sidelink measurement window configuration is a common configuration applicable to multiple responding devices, the method further comprising performing sidelink positioning measurements based at least in part on instances of sidelink PRS corresponding to a particular responding device in the sidelink measurement window configuration. The sidelink measurement window configuration is one of user equipment (UE)-based, UE-configured; UE-based, network configured; UE-assisted, UE-configured; or UE-assisted, network configured. The sidelink measurement window configuration is associated with a measurement window identifier (ID), the method further comprising reporting the sidelink positioning measurements based at least in part on the measurement window ID. The method further comprising receiving a configuration of a sidelink expected reference signal time difference (RSTD) search window, and measuring a sidelink RSTD within the sidelink expected RSTD search window. The method further comprising prioritizing the sidelink positioning measurements performed within the configured sidelink measurement window.

The processor 1606 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some implementations, the processor 1606 may be configured to operate a memory array using a memory controller. In some other implementations, a memory controller may be integrated into the processor 1606. The processor 1606 may be configured to execute computer-readable instructions stored in a memory (e.g., the memory 1608) to cause the device 1602 to perform various functions of the present disclosure.

The memory 1608 may include random access memory (RAM) and read-only memory (ROM). The memory 1608 may store computer-readable, computer-executable code including instructions that, when executed by the processor 1606 cause the device 1602 to perform various functions described herein. The code may be stored in a non-transitory computer-readable medium such as system memory or another type of memory. In some implementations, the code may not be directly executable by the processor 1606 but may cause a computer (e.g., when compiled and executed) to perform functions described herein. In some implementations, the memory 1608 may include, among other things, a basic I/O system (BIOS) which may control basic hardware or software operation such as the interaction with peripheral components or devices.

The I/O controller 1614 may manage input and output signals for the device 1602. The I/O controller 1614 may also manage peripherals not integrated into the device 1602. In some implementations, the I/O controller 1614 may represent a physical connection or port to an external peripheral. In some implementations, the I/O controller 1614 may utilize an operating system such as iOS®, ANDROID®, MS-DOS®, MS-WINDOWS®, OS/2®, UNIX®, LINUX®, or another known operating system. In some implementations, the I/O controller 1614 may be implemented as part of a processor, such as the processor 1606. In some implementations, a user may interact with the device 1602 via the I/O controller 1614 or via hardware components controlled by the I/O controller 1614.

In some implementations, the device 1602 may include a single antenna 1616. However, in some other implementations, the device 1602 may have more than one antenna 1616, which may be capable of concurrently transmitting or receiving multiple wireless transmissions. The receiver 1610 and the transmitter 1612 may communicate bi-directionally, via the one or more antennas 1616, wired, or wireless links as described herein. For example, the receiver 1610 and the transmitter 1612 may represent a wireless transceiver and may communicate bi-directionally with another wireless transceiver. The transceiver may also include a modem to modulate the packets, to provide the modulated packets to one or more antennas 1616 for transmission, and to demodulate packets received from the one or more antennas 1616.

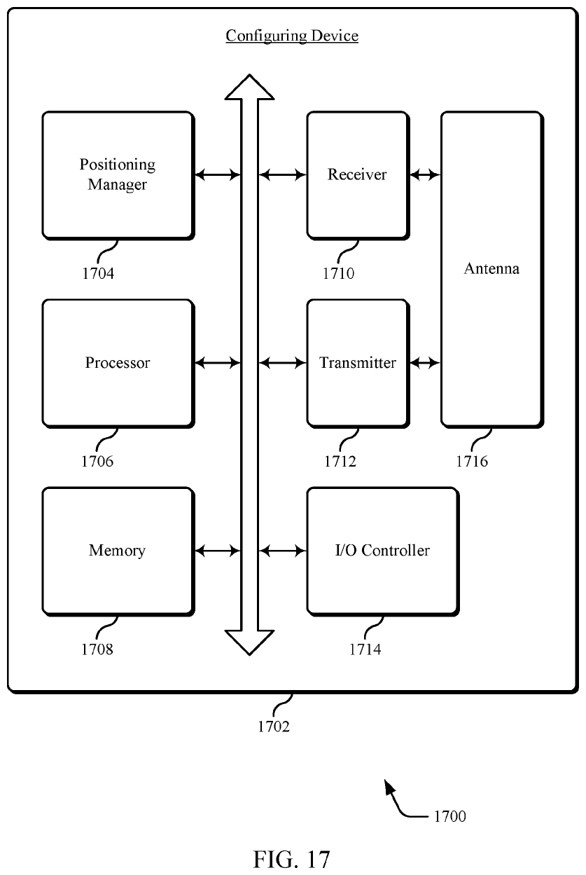

FIG. 17 illustrates an example of a block diagram 1700 of a device 1702 that supports sidelink positioning measurement procedures in accordance with aspects of the present disclosure. The device 1702 may be an example of a sidelink enabled device as a network entity and configuring device, as described herein. The device 1702 may support wireless communication and/or network signaling with one or more base stations 102, other UEs 104, core network devices and functions (e.g., core network 106), network entities and devices, or any combination thereof. The device 1702 may include components for bi-directional communications including components for transmitting and receiving communications, such as a positioning manager 1704, a processor 1706, a memory 1708, a receiver 1710, a transmitter 1712, and an I/O controller 1714. These components may be in electronic communication or otherwise coupled (e.g., operatively, communicatively, functionally, electronically, electrically) via one or more interfaces (e.g., buses).

The positioning manager 1704, the receiver 1710, the transmitter 1712, or various combinations thereof or various components thereof may be examples of means for performing various aspects of the present disclosure as described herein. For example, the positioning manager 1704, the receiver 1710, the transmitter 1712, or various combinations or components thereof may support a method for performing one or more of the functions described herein.

In some implementations, the positioning manager 1704, the receiver 1710, the transmitter 1712, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some implementations, the processor 1706 and the memory 1708 coupled with the processor 1706 may be configured to perform one or more of the functions described herein (e.g., by executing, by the processor 1706, instructions stored in the memory 1708).

Additionally or alternatively, in some implementations, the positioning manager 1704, the receiver 1710, the transmitter 1712, or various combinations or components thereof may be implemented in code (e.g., as communications management software or firmware) executed by the processor 1706. If implemented in code executed by the processor 1706, the functions of the positioning manager 1704, the receiver 1710, the transmitter 1712, or various combinations or components thereof may be performed by a general-purpose processor, a DSP, a central processing unit (CPU), an ASIC, an FPGA, or any combination of these or other programmable logic devices (e.g., configured as or otherwise supporting a means for performing the functions described in the present disclosure).

In some implementations, the positioning manager 1704 may be configured to perform various operations (e.g., receiving, monitoring, transmitting) using or otherwise in cooperation with the receiver 1710, the transmitter 1712, or both. For example, the positioning manager 1704 may receive information from the receiver 1710, send information to the transmitter 1712, or be integrated in combination with the receiver 1710, the transmitter 1712, or both to receive information, transmit information, or perform various other operations as described herein. Although the positioning manager 1704 is illustrated as a separate component, in some implementations, one or more functions described with reference to the positioning manager 1704 may be supported by or performed by the processor 1706, the memory 1708, or any combination thereof. For example, the memory 1708 may store code, which may include instructions executable by the processor 1706 to cause the device 1702 to perform various aspects of the present disclosure as described herein, or the processor 1706 and the memory 1708 may be otherwise configured to perform or support such operations.

For example, the positioning manager 1704 may support wireless communication and/or network signaling at a device (e.g., the device 1702, a sidelink network device) in accordance with examples as disclosed herein. The positioning manager 1704 and/or other device components may be configured as or otherwise support an apparatus, such as a sidelink network device (e.g., as a configuring device), including a transceiver; a processor coupled to the transceiver, the processor and the transceiver configured to cause the apparatus to: transmit a sidelink measurement window configuration to a responding device that performs sidelink positioning measurements based at least in part on the sidelink measurement window configuration; and receive the sidelink positioning measurements from the responding device.

Additionally, the apparatus (e.g., a sidelink network device as a configuring device) includes any one or combination of: the sidelink measurement window configuration is configured to a group of responding devices for groupcast sidelink positioning; the processor and the transceiver are configured to cause the apparatus to: transmit the sidelink measurement window configuration to the group of responding devices that perform respective sidelink positioning measurements; and receive the respective sidelink positioning measurements from one or more of the responding devices. The sidelink measurement window configuration is configured as a common measurement window configuration to the group of responding devices for the groupcast sidelink positioning. The sidelink measurement window configuration is configured as separate measurement window configurations to a subset of the responding devices for the groupcast sidelink positioning. The sidelink measurement window configuration includes information comprising at least one or more of a measurement window (ID) identifier, a start time, a window length, an end time, or a periodicity that indicates a number of repetitions of a sidelink positioning reference signal (PRS) transmission. The apparatus comprises at least one of a base station, a roadside unit, a location server, an anchor UE, or a target UE. The processor and the transceiver are configured to cause the apparatus to transmit a sidelink measurement window configuration utilizing one of broadcast signaling or dedicated signaling, wherein the broadcast signaling includes one of groupcast messages, positioning information blocks, or vehicle to everything (V2X) system information blocks; and the dedicated signaling includes one of PC5 radio resource control (RRC), RRC, medium access control element (MAC CE), or LTE positioning protocol (LPP). The processor and the transceiver are configured to cause the apparatus to transmit a sidelink expected RSTD search window configuration. The processor is configured to cause the apparatus to configure a sidelink RSTD search window to one or more responding devices to accurately measure the actual RSTD from a pair of anchor devices. The processor is configured to cause the apparatus to configure a sidelink RSTD search window for a same sidelink positioning frequency layer or for different sidelink positioning frequency layers. The sidelink RSTD search window configuration information includes an expected sidelink RSTD duration as a function of a time instance interval, and includes sidelink RSTD uncertainty indicating error margins of the sidelink expected RSTD window.

The positioning manager 1704 and/or other device components may be configured as or otherwise support a means for wireless communication and/or network signaling at a sidelink network device as a configuring device, including receiving a sidelink measurement window configuration from a configuring device; transmitting a sidelink measurement window configuration to a responding device that performs sidelink positioning measurements based at least in part on the sidelink measurement window configuration; and receiving the sidelink positioning measurements from the responding device.

Additionally, wireless communication at the configuring device includes any one or combination of: the sidelink measurement window configuration is configured to a group of responding devices for groupcast sidelink positioning, the method further comprising transmitting the sidelink measurement window configuration to the group of responding devices that perform respective sidelink positioning measurements, and receiving the respective sidelink positioning measurements from one or more of the responding devices. The sidelink measurement window configuration is configured as a common measurement window configuration to the group of responding devices for the groupcast sidelink positioning. The sidelink measurement window configuration is configured as separate measurement window configurations to a subset of the responding devices for the groupcast sidelink positioning. The sidelink measurement window configuration includes information comprising at least one or more of a measurement window identifier (ID), a start time, a window length, an end time, or a periodicity that indicates a number of repetitions of a sidelink positioning reference signal transmission. The method further comprising transmitting a sidelink measurement window configuration utilizing one of broadcast signaling or dedicated signaling, wherein the broadcast signaling includes one of groupcast messages, positioning information blocks, or vehicle to everything (V2X) system information blocks, and the dedicated signaling includes one of PC5 radio resource control (RRC), RRC, medium access control element (MAC CE), or LTE positioning protocol (LPP). The method further comprising transmitting a sidelink expected RSTD search window configuration. The method further comprising configuring a sidelink RSTD search window to one or more responding devices to accurately measure the actual RSTD from a pair of anchor devices. The method further comprising configuring a sidelink RSTD search window for a same sidelink positioning frequency layer or for different sidelink positioning frequency layers. The sidelink RSTD search window configuration information includes an expected sidelink RSTD duration as a function of a time instance interval, and includes sidelink RSTD uncertainty indicating error margins of the sidelink expected RSTD window.

The processor 1706 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some implementations, the processor 1706 may be configured to operate a memory array using a memory controller. In some other implementations, a memory controller may be integrated into the processor 1706. The processor 1706 may be configured to execute computer-readable instructions stored in a memory (e.g., the memory 1708) to cause the device 1702 to perform various functions of the present disclosure.

The memory 1708 may include random access memory (RAM) and read-only memory (ROM). The memory 1708 may store computer-readable, computer-executable code including instructions that, when executed by the processor 1706 cause the device 1702 to perform various functions described herein. The code may be stored in a non-transitory computer-readable medium such as system memory or another type of memory. In some implementations, the code may not be directly executable by the processor 1706 but may cause a computer (e.g., when compiled and executed) to perform functions described herein. In some implementations, the memory 1708 may include, among other things, a basic I/O system (BIOS) which may control basic hardware or software operation such as the interaction with peripheral components or devices.

The I/O controller 1714 may manage input and output signals for the device 1702. The I/O controller 1714 may also manage peripherals not integrated into the device 1702. In some implementations, the I/O controller 1714 may represent a physical connection or port to an external peripheral. In some implementations, the I/O controller 1714 may utilize an operating system such as iOS®, ANDROID®, MS-DOS®, MS-WINDOWS®, OS/2®, UNIX®, LINUX®, or another known operating system. In some implementations, the I/O controller 1714 may be implemented as part of a processor, such as the processor 1706. In some implementations, a user may interact with the device 1702 via the I/O controller 1714 or via hardware components controlled by the I/O controller 1714.

In some implementations, the device 1702 may include a single antenna 1716. However, in some other implementations, the device 1702 may have more than one antenna 1716, which may be capable of concurrently transmitting or receiving multiple wireless transmissions. The receiver 1710 and the transmitter 1712 may communicate bi-directionally, via the one or more antennas 1716, wired, or wireless links as described herein. For example, the receiver 1710 and the transmitter 1712 may represent a wireless transceiver and may communicate bi-directionally with another wireless transceiver. The transceiver may also include a modem to modulate the packets, to provide the modulated packets to one or more antennas 1716 for transmission, and to demodulate packets received from the one or more antennas 1716.

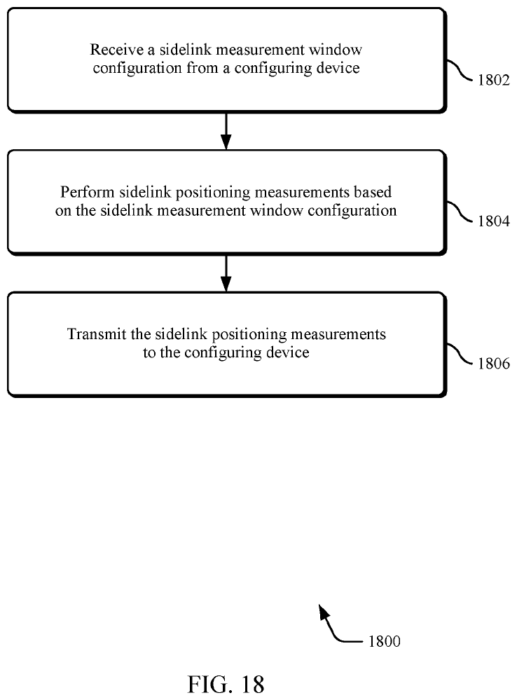

FIG. 18 illustrates a flowchart of a method 1800 that supports sidelink positioning measurement procedures in accordance with aspects of the present disclosure. The operations of the method 1800 may be implemented by a device or its components as described herein. For example, the operations of the method 1800 may be performed by a device, such as a UE 104 configured as a sidelink responding device as described with reference to FIGS. 1 through 17. In some implementations, the device may execute a set of instructions to control the function elements of the device to perform the described functions. Additionally, or alternatively, the device may perform aspects of the described functions using special-purpose hardware.

At 1802, the method may include receiving a sidelink measurement window configuration from a configuring device. The operations of 1802 may be performed in accordance with examples as described herein. In some implementations, aspects of the operations of 1802 may be performed by a device as described with reference to FIG. 1.

At 1804, the method may include performing sidelink positioning measurements based on the sidelink measurement window configuration. The operations of 1804 may be performed in accordance with examples as described herein. In some implementations, aspects of the operations of 1804 may be performed by a device as described with reference to FIG. 1.

At 1806, the method may include transmitting the sidelink positioning measurements to the configuring device. The operations of 1806 may be performed in accordance with examples as described herein. In some implementations, aspects of the operations of 1806 may be performed by a device as described with reference to FIG. 1.

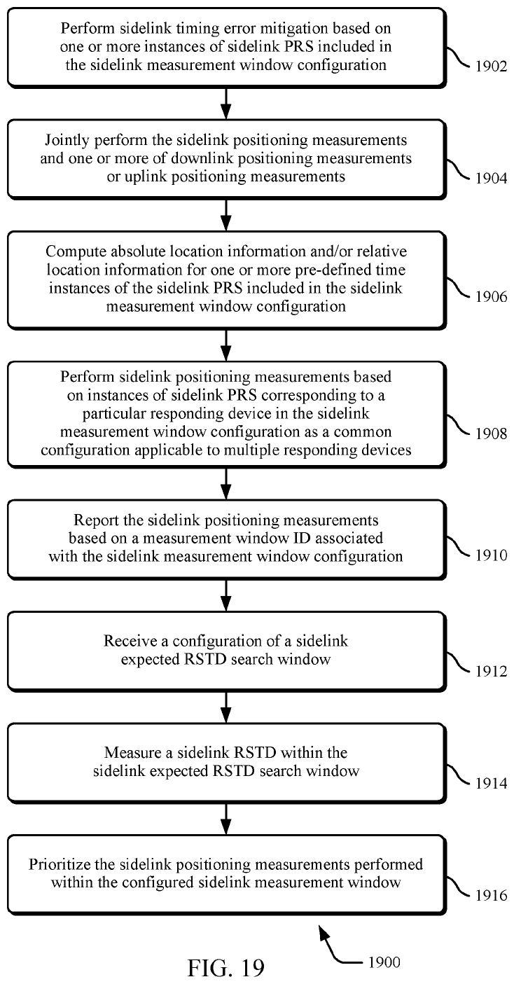

FIG. 19 illustrates a flowchart of a method 1900 that supports sidelink positioning measurement procedures in accordance with aspects of the present disclosure. The operations of the method 1900 may be implemented by a device or its components as described herein. For example, the operations of the method 1900 may be performed by a device, such as a UE 104 configured as a sidelink responding device as described with reference to FIGS. 1 through 17. In some implementations, the device may execute a set of instructions to control the function elements of the device to perform the described functions. Additionally, or alternatively, the device may perform aspects of the described functions using special-purpose hardware.

At 1902, the method may include performing sidelink timing error mitigation based on one or more instances of sidelink PRS included in the sidelink measurement window configuration. The operations of 1902 may be performed in accordance with examples as described herein. In some implementations, aspects of the operations of 1902 may be performed by a device as described with reference to FIG. 1.

At 1904, the method may include jointly performing the sidelink positioning measurements and one or more of downlink positioning measurements or uplink positioning measurements. The operations of 1904 may be performed in accordance with examples as described herein. In some implementations, aspects of the operations of 1904 may be performed by a device as described with reference to FIG. 1.

At 1906, the method may include computing absolute location information and/or relative location information for one or more pre-defined time instances of the sidelink PRS included in the sidelink measurement window configuration. The operations of 1906 may be performed in accordance with examples as described herein. In some implementations, aspects of the operations of 1906 may be performed by a device as described with reference to FIG. 1.

At 1908, the method may include performing sidelink positioning measurements based on instances of sidelink PRS corresponding to a particular responding device in the sidelink measurement window configuration as a common configuration applicable to multiple responding devices. The operations of 1908 may be performed in accordance with examples as described herein. In some implementations, aspects of the operations of 1908 may be performed by a device as described with reference to FIG. 1.

At 1910, the method may include reporting the sidelink positioning measurements based on a measurement window ID associated with the sidelink measurement window configuration. The operations of 1910 may be performed in accordance with examples as described herein. In some implementations, aspects of the operations of 1910 may be performed by a device as described with reference to FIG. 1.

At 1912, the method may include receiving a configuration of a sidelink expected RSTD search window. The operations of 1912 may be performed in accordance with examples as described herein. In some implementations, aspects of the operations of 1912 may be performed by a device as described with reference to FIG. 1.

At 1914, the method may include measuring a sidelink RSTD within the sidelink expected RSTD search window. The operations of 1914 may be performed in accordance with examples as described herein. In some implementations, aspects of the operations of 1914 may be performed by a device as described with reference to FIG. 1.

At 1916, the method may include prioritizing the sidelink positioning measurements performed within the configured sidelink measurement window. The operations of 1916 may be performed in accordance with examples as described herein. In some implementations, aspects of the operations of 1916 may be performed by a device as described with reference to FIG. 1.

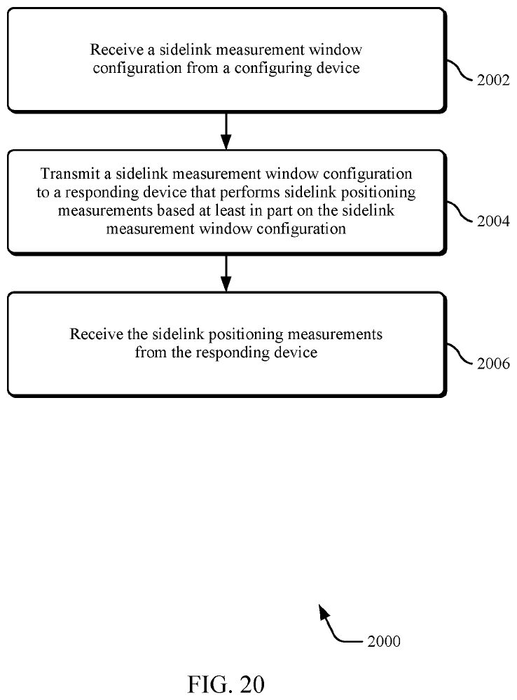

FIG. 20 illustrates a flowchart of a method 2000 that supports sidelink positioning measurement procedures in accordance with aspects of the present disclosure. The operations of the method 2000 may be implemented by a device or its components as described herein. For example, the operations of the method 2000 may be performed by a network device configured as a sidelink configuring device, such as described with reference to FIGS. 1 through 17. In some implementations, the device may execute a set of instructions to control the function elements of the device to perform the described functions. Additionally, or alternatively, the device may perform aspects of the described functions using special-purpose hardware.

At 2002, the method may include receiving a sidelink measurement window configuration from a configuring device. The operations of 2002 may be performed in accordance with examples as described herein. In some implementations, aspects of the operations of 2002 may be performed by a device as described with reference to FIG. 1.

At 2004, the method may include transmitting a sidelink measurement window configuration to a responding device that performs sidelink positioning measurements based at least in part on the sidelink measurement window configuration. The operations of 2004 may be performed in accordance with examples as described herein. In some implementations, aspects of the operations of 2004 may be performed by a device as described with reference to FIG. 1.

At 2006, the method may include receiving the sidelink positioning measurements from the responding device. The operations of 2006 may be performed in accordance with examples as described herein. In some implementations, aspects of the operations of 2006 may be performed by a device as described with reference to FIG. 1.

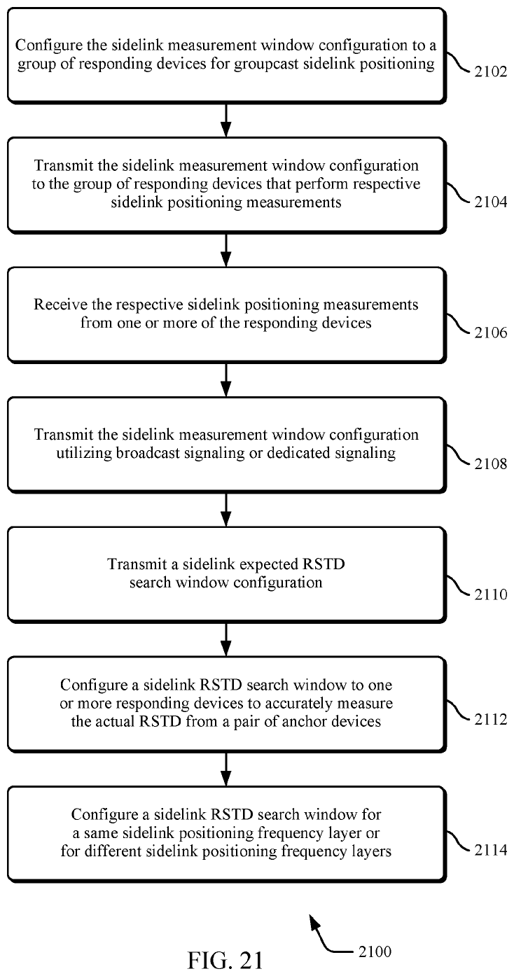

FIG. 21 illustrates a flowchart of a method 2100 that supports sidelink positioning measurement procedures in accordance with aspects of the present disclosure. The operations of the method 2100 may be implemented by a device or its components as described herein. For example, the operations of the method 2100 may be performed by a network device configured as a sidelink configuring device, such as described with reference to FIGS. 1 through 17. In some implementations, the device may execute a set of instructions to control the function elements of the device to perform the described functions. Additionally, or alternatively, the device may perform aspects of the described functions using special-purpose hardware.

At 2102, the method may include configuring the sidelink measurement window configuration to a group of responding devices for groupcast sidelink positioning. The sidelink measurement window configuration is configured as a common measurement window configuration to the group of responding devices for the groupcast sidelink positioning. Alternatively, the sidelink measurement window configuration is configured as separate measurement window configurations to a subset of the responding devices for the groupcast sidelink positioning. The operations of 2102 may be performed in accordance with examples as described herein. In some implementations, aspects of the operations of 2102 may be performed by a device as described with reference to FIG. 1.

At 2104, the method may include transmitting the sidelink measurement window configuration to the group of responding devices that perform respective sidelink positioning measurements. The operations of 2104 may be performed in accordance with examples as described herein. In some implementations, aspects of the operations of 2104 may be performed by a device as described with reference to FIG. 1.

At 2106, the method may include receiving the respective sidelink positioning measurements from one or more of the responding devices. The operations of 2106 may be performed in accordance with examples as described herein. In some implementations, aspects of the operations of 2106 may be performed by a device as described with reference to FIG. 1.

At 2108, the method may include transmitting the sidelink measurement window configuration utilizing broadcast signaling or dedicated signaling. The operations of 2108 may be performed in accordance with examples as described herein. In some implementations, aspects of the operations of 2108 may be performed by a device as described with reference to FIG. 1.

At 2110, the method may include transmitting a sidelink expected RSTD search window configuration. The operations of 2110 may be performed in accordance with examples as described herein. In some implementations, aspects of the operations of 2110 may be performed by a device as described with reference to FIG. 1.

At 2112, the method may include configuring a sidelink RSTD search window to one or more responding devices to accurately measure the actual RSTD from a pair of anchor devices. The operations of 2112 may be performed in accordance with examples as described herein. In some implementations, aspects of the operations of 2112 may be performed by a device as described with reference to FIG. 1.

At 2114, the method may include configuring a sidelink RSTD search window for a same sidelink positioning frequency layer or for different sidelink positioning frequency layers. The operations of 2114 may be performed in accordance with examples as described herein. In some implementations, aspects of the operations of 2114 may be performed by a device as described with reference to FIG. 1.

It should be noted that the methods described herein describe possible implementations, and that the operations and the steps may be rearranged or otherwise modified and that other implementations are possible. Further, aspects from two or more of the methods may be combined. The order in which the methods are described is not intended to be construed as a limitation, and any number or combination of the described method operations may be performed in any order to perform a method, or an alternate method.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor.

Any connection may be properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C, or AB or AC or BC, or ABC (i.e., A and B and C). Similarly, a list of one or more of A, B, or C means A or B or C, or AB or AC or BC, or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on. Further, as used herein, including in the claims, a “set” may include one or more elements.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form to avoid obscuring the concepts of the described example.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. A user equipment (UE) for wireless communication, comprising:
at least one memory; and
at least one processor coupled with the at least one memory and configured to cause the UE to:
receive, from a configuring device, a sidelink measurement window configuration;
perform sidelink positioning measurements based at least in part on the sidelink measurement window configuration; and
transmit, to the configuring device, the sidelink positioning measurements for the UE.

2. The UE of claim 1, wherein:
the sidelink measurement window configuration includes multiple instances of sidelink positioning reference signals (PRS); and
the sidelink positioning measurements are averaged over the multiple instances of the sidelink PRS.

3. The UE of claim 1, wherein:
the sidelink measurement window configuration includes multiple instances of sidelink positioning reference signals (PRS); and
the at least one processor is configured to cause the UE to perform sidelink timing error mitigation based on one or more of the multiple instances of the sidelink PRS.

4. The UE of claim 1, wherein the at least one processor is configured to cause the UE to jointly perform the sidelink positioning measurements and one or more of downlink positioning measurements or uplink positioning measurements.

5. The UE of claim 1, wherein:
the sidelink measurement window configuration includes multiple pre-defined time instances of sidelink PRS; and
the at least one processor is configured to cause the UE to compute at least one of absolute location information or relative location information for one or more of the multiple pre-defined time instances of the sidelink PRS.

6. The UE of claim 1, wherein:
the sidelink measurement window configuration is a common configuration applicable to multiple responding devices; and
the at least one processor is configured to cause the UE to perform the sidelink positioning measurements based at least in part on instances of sidelink PRS corresponding to the UE in the sidelink measurement window configuration.

7. The UE of claim 1, wherein the sidelink measurement window configuration is one of user equipment (UE) UE-based, UE-configured; UE-based, network configured; UE-assisted, UE-configured; or UE-assisted, network configured.

8. The UE of claim 1, wherein:
the sidelink measurement window configuration is associated with a measurement window identifier (ID); and
the at least one processor and the transceiver are is configured to cause the UE to report the sidelink positioning measurements based at least in part on the measurement window ID.

9. The UE of claim 1, wherein the at least one processor is configured to cause the UE to:
receive a configuration of a sidelink expected reference signal time difference (RSTD) search window; and
measure a sidelink RSTD within the sidelink expected RSTD search window.

10. An apparatus, comprising:
at least one memory; and
at least one processor coupled with the at least one memory and configured to cause the apparatus to:
transmit a sidelink measurement window configuration to a responding device that performs sidelink positioning measurements based at least in part on the sidelink measurement window configuration; and
receive, from the responding device, the sidelink positioning measurements.

11. The apparatus of claim 10, wherein:
the sidelink measurement window configuration is configured to a group of responding devices for groupcast sidelink positioning;
the at least one processor is configured to cause the apparatus to:
transmit the sidelink measurement window configuration to the group of responding devices that perform respective sidelink positioning measurements; and
receive the respective sidelink positioning measurements from one or more of the responding devices of the group of responding devices.

12. The apparatus of claim 11, wherein the sidelink measurement window configuration is configured as a common measurement window configuration to the group of responding devices for the groupcast sidelink positioning.

13. The apparatus of claim 11, wherein the sidelink measurement window configuration is configured as separate measurement window configurations to a subset of the group of responding devices for the groupcast sidelink positioning.

14. The apparatus of claim 10, wherein the sidelink measurement window configuration includes information comprising at least one or more of a measurement window identifier (ID), a start time, a window length, an end time, or a periodicity that indicates a number of repetitions of a sidelink positioning reference signal (PRS) transmission.

15. A method performed by a user equipment (UE), the method comprising:
receiving, from a configuring device, a sidelink measurement window configuration;
performing sidelink positioning measurements based at least in part on the sidelink measurement window configuration; and
transmitting, to the configuring device, the sidelink positioning measurements.

16-20. (canceled)

21. A processor for wireless communication, comprising:
at least one controller coupled with at least one memory and configured to cause the processor to:
receive, from a configuring device, a sidelink measurement window configuration;
perform sidelink positioning measurements based at least in part on the sidelink measurement window configuration; and
transmit, to the configuring device, the sidelink positioning measurements.

22. The processor of claim 21, wherein:
the sidelink measurement window configuration includes multiple instances of sidelink positioning reference signals (PRS); and one of:
the sidelink positioning measurements are averaged over the multiple instances of the sidelink PRS; or
sidelink timing error mitigation is performed based on one or more of the multiple instances of the sidelink PRS.

23. The processor of claim 21, wherein the at least one controller is configured to cause the processor to jointly perform the sidelink positioning measurements and one or more of downlink positioning measurements or uplink positioning measurements.

24. The processor of claim 21, wherein:
the sidelink measurement window configuration includes multiple pre-defined time instances of sidelink PRS; and
the at least one controller is configured to cause the processor to compute at least one of absolute location information or relative location information for one or more of the multiple pre-defined time instances of the sidelink PRS.

25. The processor of claim 21, wherein:
the sidelink measurement window configuration is a common configuration applicable to multiple responding devices; and
the at least one controller is configured to cause the processor to perform the sidelink positioning measurements based at least in part on instances of sidelink PRS in the sidelink measurement window configuration.
